(19) United States
(12) Patent Application Publication
(10) Pub. No.: US 2026/0050395 A1
(43) Pub. Date: Feb. 19, 2026

(54) STORAGE DEVICE FOR LARGE LANGUAGE MODEL INFERENCE, OPERATION METHOD THEREOF, AND ELECTRONIC DEVICE INCLUDING THE SAME

(71) Applicant: SAMSUNG ELECTRONICS CO., LTD., Suwon-si (KR)

(72) Inventors: Jungwook CHOI, Seoul (KR); Byungmin Ahn, Suwon-si (KR); Hyeonggyu Jeong, Seoul (KR); Kibin Park, Seoul (KR); Inyeong Song, Seoul (KR)

(73) Assignee: SAMSUNG ELECTRONICS CO., LTD., Suwon-si (KR)

(21) Appl. No.: 19/086,350

(22) Filed: Mar. 21, 2025

(30) Foreign Application Priority Data
Aug. 16, 2024 (KR) 10-2024-0109869

(51) Int. Cl. G06F 3/06

(52) U.S. Cl. CPC G06F 3/0655; G06F 3/0604; G06F 3/0679

(57) ABSTRACT

Disclosed is an operation method of a storage controller which is connected to a plurality of non-volatile memory devices configured to store inference data of a large language model (LLM) through a plurality of channels. The method includes receiving a first request for writing a first key vector corresponding to a first data type, storing the first key vector in at least one first non-volatile memory device connected to one or more first channels among the plurality of channels, by referring to the first data type and a channel table, and updating the channel table such that a channel corresponding to the first data type is changed to a second channel among the plurality of channels.

### CROSS-REFERENCE TO RELATED APPLICATION(S)

This application claims priority under 35 U.S.C. § 119 to Korean Patent Application No. 10-2024-0109869 filed on Aug. 16, 2024, in the Korean Intellectual Property Office, the disclosure of which is herein incorporated by reference herein in its entirety.

### BACKGROUND

One or more example embodiments of the disclosure described herein relate to a semiconductor memory device, and more particularly, relate to a memory device for large language model inference, an operation method thereof, and an electronic device including the same.

Various accelerators are used in machine learning or an artificial intelligence model. Also, various buffer memories are used to store program codes, source codes, or data to be executed by the accelerators, and a high bandwidth memory (HBM) device or a dynamic random access memory (DRAM) device is representatively used as a buffer memory.

The above devices may provide data related to the operation of the accelerator at high speed, but the issue that costs increase to implement a high-capacity buffer memory is caused. As the artificial intelligence model develops, the capacity of data of the model is increasing more and more. In this case, a memory device capable of appropriately storing a high-capacity model is required. Also, there is required a method of storing data so as to be suitable for the inference of the artificial intelligence model.

### SUMMARY

Embodiments of the disclosure provide a memory device providing storage of a high-capacity artificial intelligence model and capable of storing data to suitable for an inference operation of the model, an operation method thereof, and an electronic device including the same.

According to an aspect of an example embodiment, an operation method of a storage controller which is connected to a plurality of non-volatile memory devices configured to store inference data of a large language model (LLM) through a plurality of channels includes receiving a first request for writing a first key vector corresponding to a first data type, storing the first key vector in at least one first non-volatile memory device connected to one or more first channels among the plurality of channels, by referring to the first data type and a channel table, and updating the channel table such that a channel corresponding to the first data type is changed to a second channel among the plurality of channels.

According to an aspect of an example embodiment, a storage device which is configured to store inference data of a large language model includes a plurality of non-volatile memory devices, and a storage controller that is connected to the plurality of non-volatile memory devices through a plurality of channels and controls the plurality of non-volatile memory devices. The storage controller manages a channel table. The channel table includes a relationship between a first data type and a channel, among the plurality of channels, to which next data of the first data type are to be sent, and a relationship between a second data type and a channel, among the plurality of channels, to which next data of the second data type are to be sent.

According to an aspect of an example embodiment, an electronic device which implements inference of a large language model includes a processor that performs learning and the inference of the large language model, and a storage device that stores model data of the large language model and provides the model data to the processor. The storage device includes a storage controller configured to control the storage device, and a plurality of non-volatile memory devices that are connected to the storage controller through a plurality of channels and stores the model data. The storage controller is configured to manage a channel table including a relationship between a first data type and a channel to which next data of the first data type are to be sent.

### BRIEF DESCRIPTION OF DRAWINGS

The above and other objects and features of the disclosure will become apparent by describing in detail example embodiments thereof with reference to the accompanying drawings.

FIG. 1 is a block diagram illustrating an electronic device, according to one or more example embodiments of the disclosure.

FIG. 2 is a block diagram illustrating an example of a storage device of FIG. 1, according to one or more example embodiments of the disclosure.

FIG. 3 is a block diagram illustrating a storage controller of FIG. 2 in detail, according to one or more example embodiments of the disclosure.

FIG. 4 is a diagram illustrating an example of a form in which a processor of FIG. 1 writes and reads data, according to one or more example embodiments of the disclosure.

FIG. 5 is a diagram illustrating an example of a request generated by a processor of FIG. 1, according to one or more example embodiments of the disclosure.

FIGS. 6A and 6B are tables illustrating examples of channel tables managed by a storage controller of FIG. 2, according to one or more example embodiments of the disclosure.

FIG. 7 is a diagram illustrating an example of a mapping table managed by a storage controller of FIG. 2, according to one or more example embodiments of the disclosure.

FIGS. 8A to 8C are block diagrams illustrating an example of a manner in which a memory device of FIG. 2 stores data, according to one or more example embodiments of the disclosure.

FIG. 9 is a flowchart illustrating an example of a method in which a storage device of FIGS. 1 to 8C writes data, according to one or more example embodiments of the disclosure.

FIG. 10 is a flowchart illustrating an example of a method in which an electronic device of FIGS. 1 to 8C writes data, according to one or more example embodiments of the disclosure.

FIGS. 11A and 11B are flowcharts illustrating an example of a method in which an electronic device of FIGS. 1 to 8C reads data, according to one or more example embodiments of the disclosure.

FIG. 12 is a block diagram illustrating an electronic device according to one or more example embodiments of the disclosure.

FIG. 13 is a flowchart illustrating an example of a data write method of an electronic device of FIG. 12, according to one or more example embodiments of the disclosure.

FIG. 14 is a flowchart illustrating an example of a data read method of an electronic device of FIG. 12, according to one or more example embodiments of the disclosure.

FIG. 15 is a block diagram illustrating an electronic system, according to one or more example embodiments of the disclosure.

FIG. 16 is a block diagram illustrating a system, according to one or more example embodiments of the disclosure.

### DETAILED DESCRIPTION

Below, example embodiments of the disclosure will be described in detail and clearly to such an extent that an ordinary one in the art easily carries out the disclosure.

In the detailed description, components which are described with reference to the terms “module”, “block”, “˜er or ˜or”, etc. and function blocks which are illustrated in drawings will be implemented in the form of software or hardware or a combination thereof. For example, the software may include a machine code, firmware, an embedded code, and application software. For example, the hardware may include an electrical circuit, an electronic circuit (e.g., an analog circuit or a digital circuit), a processor, a computer, an integrated circuit, integrated circuit cores, a pressure sensor, an inertial sensor, a microelectromechanical system (MEMS), a passive element, or a combination thereof.

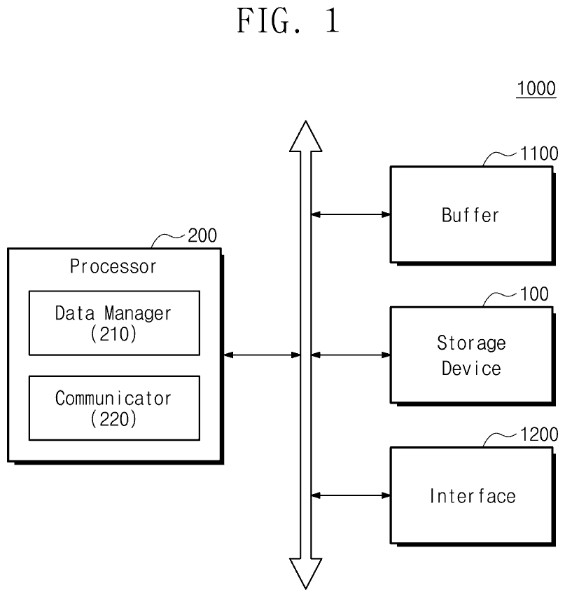

FIG. 1 is a block diagram illustrating an electronic device according to one or more example embodiments of the disclosure. Referring to FIG. 1, an electronic device 1000 may include a storage device 100, a processor 200, a buffer 1100, and an interface 1200.

The electronic device 1000 may implement machine learning or artificial intelligence (AI); alternatively, the electronic device 1000 may perform calculations (or operations or computations) related to implementation of the artificial intelligence and may provide a result. In an embodiment, the electronic device 1000 may be various devices or may be included in various devices. For example, the electronic device 1000 may be a personal computer (PC), a tablet PC, a laptop PC, a personal digital assistant (PDA), a smartphone, a server, a data center, etc. or may be included therein.

In an embodiment, the electronic device 1000 may implement deep learning such as a deep neural network (DNN), a convolution neural network (CNN), or a transformer, may implement a training operation or an inference operation of the machine learning, or may implement the artificial intelligence. For example, the electronic device 1000 may implement a transformer structure for large language model (LLM) inference. In an embodiment, the electronic device 1000 may perform calculations related to implementation of the artificial intelligence, the machine learning, etc. and may provide a result (e.g., to any other electronic device or etc.).

The storage device 100 may store data related to the operation of the electronic device 1000. In an embodiment, the storage device 100 may store data of a model of the artificial intelligence implemented by the electronic device 1000. For example, the storage device 100 may store data of a model for implementing the transformer structure. For example, the storage device 100 may provide or (e.g., temporarily) store data related to the operation of the processor 200 or may (e.g., temporarily) store data generated by the operation.

The storage device 100 may include at least one or more memory devices. In an embodiment, the storage device 100 may include a plurality of memory devices depending on the purpose. For example, the storage device 100 may include a first memory device configured to store a result of the operation of the processor 200 and/or a second memory device configured to store data to be used for the operation of the processor 200 and/or data generated during the operation of the processor 200 and/or configured to provide data related to the operation of the processor 200.

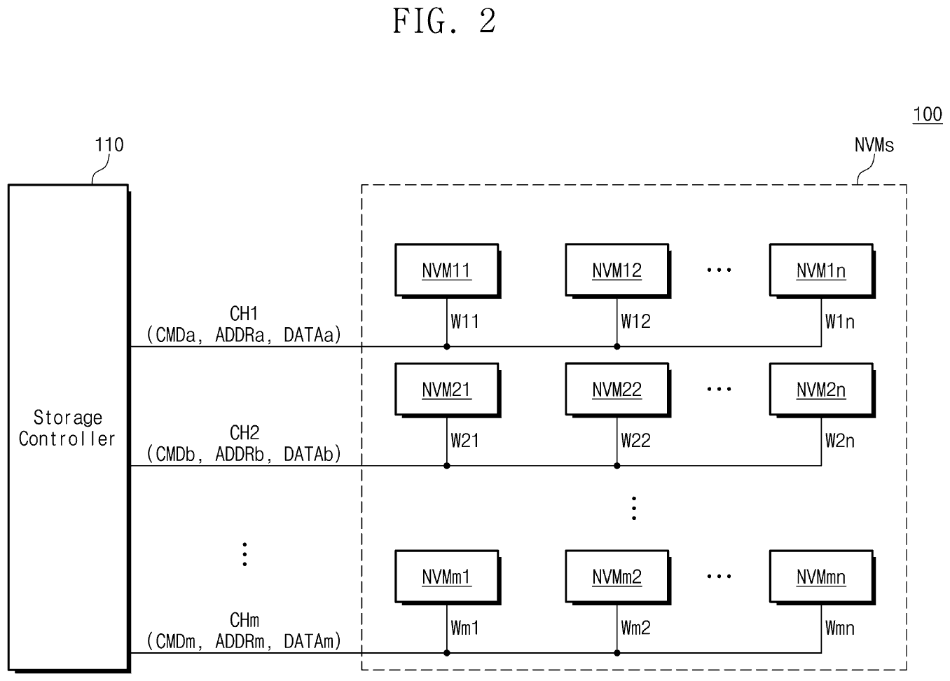

In an embodiment, the storage device 100 may include a memory device which includes non-volatile memory cells. For example, the storage device 100 may include a memory device which includes NAND flash memory cells. Below, the description will be given based on an example in which the storage device 100 includes a memory device(s) including a NAND flash memory, but the scope of the disclosure is not limited thereto. The memory device which the storage device 100 includes and an operation of the memory device will be described in detail with reference to FIGS. 2 to 17. In FIG. 1, the description is given based on an embodiment in which the electronic device 1000 includes the storage device 100 therein, but the scope of the disclosure is not limited thereto. For example, it should be understood that an embodiment in which the storage device 100 is provided outside the electronic device 1000 also belongs to the scope of the disclosure.

The processor 200 may perform calculations related to the operation of the electronic device 1000. In an embodiment, the processor 200 may perform calculations related to the electronic device 1000 to perform the machine learning or to implement the artificial intelligence (or the artificial intelligence model). For example, depending on the artificial intelligence model to be implemented, the processor 200 may perform a weight calculation or may perform an inference operation.

The processor 200 may include at least one or more processors. In an embodiment, the processor 200 may include a general-purpose processor or a specific-purpose processor. In an embodiment, the processor 200 may include at least one or more processors or at least one or more accelerators. For example, the processor 200 may include a central processing unit (CPU) or a processor such as an application processor (AP). For example, the processor 200 may include at least one or more of accelerators such as a graphics processing unit (GPU), a neural processing unit (NPU), a neuromorphic processor (NP), or a tensor processing unit (TPU). For another example, the processor 200 may include a CPU and a GPU (or an NPU). Referring to FIG. 1, the processor 200 may include a data manager 210 and a communicator 220.

The data manager 210 may manage data which the processor 200 uses. The data manager 210 may manage data to be stored in the storage device 100 or the buffer 1100. In an embodiment, the data manager 210 may transform, change, connect, concatenate, or process data received from the storage device 100 such that the received data are used for a calculation operation of the processor 200. For example, the data manager 210 may generate data to be used for the LLM inference, based on data sequentially received from the storage device 100.

In an embodiment, the data manager 210 may select a location at which data generated by the processor 200 are to be stored or a location at which data generated by the processor 200 are to be temporarily stored. For example, the data manager 210 may select a location of the buffer 1100 or the storage device 100, at which data generated by the operation of the processor 200 are to be stored. In an embodiment, the data manager 210 may transfer data to the buffer 1100 or the storage device 100 through the communicator 220.

In an embodiment, the data manager 210 may manage the form by which data generated by the operation of the processor 200 are stored in the storage device 100 or the buffer 1100. For example, the data manager 210 may divide key-vector data generated by the LLM inference operation of the processor 200 in units of arbitrary size (e.g., a size of one physical page of a NAND flash memory block), to be transferred to the storage device 100.

The communicator 220 may perform communication between the processor 200 and any other component of the electronic device 1000. In an embodiment, the communicator 220 may perform communication between the processor 200 and any other components in compliance with various interface protocols or various communication protocols. For example, the communicator 220 may perform communication with any other components in compliance with various communication protocols such as a peripheral component interconnect express (PCIe) protocol or a universal flash storage (UFS) protocol.

The data manager 210 and the communicator 220 may be functionally distinguished from each other, and the scope of the disclosure is not limited thereto. In an embodiment, at least one processor included in the processor 200 may perform the above operations of the data manager 210. For example, the CPU included in the processor 200 may perform the above operations of the data manager 210.

The buffer 1100 may store data which are used for the operation of the electronic device 1000. In an embodiment, the buffer 1100 may store a source code, a program code, data, etc. executable by the processor 200. In an embodiment, the buffer 1100 may load a program or a source code stored in the storage device 100 and may transfer the loaded program or source code to the processor 200. In an embodiment, the buffer 1100 may include a memory device. For example, the buffer 1100 may include a volatile memory device, for example but not limited to, such as a dynamic random access memory (DRAM) or a static RAM (SRAM) or a non-volatile memory device such as, for example but not limited to, a magnetic RAM (MRAM), a spin-torque transfer MRAM (STTMRAM), a phase RAM (PRAM), a ferro-electric RAM (FeRAM), a ferro-electric field effect transistor (FeFET), or a NAND flash memory.

The interface 1200 may perform communication of the electronic device 1000 or may receive an input. In an embodiment, the interface 1200 may enable the communication between the electronic device 1000 and an external device. In an embodiment, the interface 1200 may receive an input for a control of the electronic device 1000. For example, the interface 1200 may be connected to an input device, which will receive an input, such as a keyboard or a mouse and may receive a user input. In an embodiment, the interface 1200 may output a result of the operation of the electronic device 1000. For example, the interface 1200 may be connected to an output device such as a display or a speaker and may output the operation result of the electronic device 1000.

When the electronic device 1000 implements various artificial intelligence models or performs the inference operation, model data may be large. The amount of data to be read from the storage device 100 for one inference operation of the electronic device 1000 may be large. For the processor 200 to smoothly implement a model or to smoothly perform the inference operation, the storage device 100 may need to perform a method or a memory device capable of quickly and efficiently providing data (e.g., a large amount of data) to the processor 200 to be used by the processor 200. Below, a memory device capable of providing data to be used for the artificial intelligence inference operation quickly and capable of enabling rapid model implementation, and a method of writing data to the memory device will be described in detail with reference to the following drawings.

FIG. 2 is a block diagram illustrating an example of a storage device of FIG. 1, according to one or more example embodiments of the disclosure. Referring to FIG. 2, the storage device 100 may include a storage controller 110 and a non-volatile memory devices NVMs. The storage device 100 may support a plurality of channels CH1 to CHm, and the storage controller 110 may be connected to the non-volatile memory devices NVMs through the plurality of channels CH1 to CHm. For example, the storage device 100 may be implemented with a memory device such as a solid state drive (SSD).

Each of non-volatile memory devices NVM11 to NVMmn may be connected to one of the plurality of channels CH1 to CHm through a corresponding way. For example, the non-volatile memory devices NVM11 to NVM1n may be respectively connected to the first channel CH1 through first ways W11 to W1n among ways W11 to Wmn, and the non-volatile memory devices NVM21 to NVM2n may be respectively connected to the second channel CH2 through second ways W21 to W2n among the ways W11 to Wmn. In an embodiment, each of the non-volatile memory devices NVM11 to NVMmn may be implemented in an arbitrary memory unit capable of operating depending on an individual command from the storage controller 110. For example, each of the non-volatile memory devices NVM11 to NVMmn may be implemented with a chip or a die, but the disclosure is not limited thereto.

In an embodiment, the 11th non-volatile memory device NVM11 may include a plurality of planes and a peripheral circuit. Each of the plurality of planes may include a plurality of memory blocks. Each of the plurality of memory blocks may include a plurality of pages. In an embodiment, memory blocks included in the same plane may be configured to share the same bit lines, but the scope of the disclosure is not limited thereto. In an embodiment, the plurality of planes of the 11th non-volatile memory device NVM11 may operate independently of each other or in parallel. It should be understood that the non-volatile memory devices NVM11 to NVMmn are the same as or similar to the 11th non-volatile memory device NVM11.

The storage controller 110 may transmit and/or receive signals to and/or from the non-volatile memory devices NVMs through the plurality of channels CH1 to CHm. For example, the storage controller 110 may send commands CMDa to CMDm, addresses ADDRa to ADDRm, and data DATAa to DATAm to the non-volatile memory devices NVMs through the channels CH1 to CHm and/or may receive the data DATAa to DATAm from the non-volatile memory devices NVMs through the channels CH1 to CHm.

The storage controller 110 may select one of non-volatile memory devices connected to each channel and may send/receive signals to/from the selected non-volatile memory device through each channel. For example, the storage controller 110 may select the 11th non-volatile memory device NVM11 among the non-volatile memory devices NVM11 to NVM1n connected to the first channel CH1. The storage controller 110 may send the command CMDa, the address ADDRa, and the data DATAa to the selected 11th non-volatile memory device NVM11 through the first channel CH1 or may receive the data DATAa from the selected 11th non-volatile memory device NVM11 through the first channel CH1.

The storage controller 110 may send/receive signals to/from the non-volatile memory devices NVMs through different channels in parallel. For example, while the storage controller 110 sends the command CMDa to the non-volatile memory devices NVMs through the first channel CH1, the storage controller 110 may send the command CMDb to the non-volatile memory devices NVMs through the second channel CH2. For example, while the storage controller 110 receives the data DATAa from the non-volatile memory devices NVMs through the first channel CH1, the storage controller 110 may receive the data DATAb from the non-volatile memory devices NVMs through the second channel CH2.

In an embodiment, at least some of the non-volatile memory devices NVM11 to NVMmn may constitute the same way. For example, a first part NVM11 and NVM21 to NVMm1 of the non-volatile memory devices may constitute a first way W11 and W21 to Wm1. For another example, a second part NVM12 and NVM22 to NVMm2 of the non-volatile memory devices may constitute a second way W12 and W22 to Wm2, and an n-th part NVM1n and NVM2n to NVMmn of the non-volatile memory devices may constitute an n-th way W1n and W2n to Wmn.

In an embodiment, the storage controller 110 may simultaneously select non-volatile memory devices constituting the same way. For example, the storage controller 110 may select the first part NVM11 and NVM21 to NVMm1 of the non-volatile memory devices, which constitute the first way W11 and W21 to Wm1, and may send/receive signals to/from the selected first part NVM11 and NVM21 to NVMm1 of the non-volatile memory devices through the plurality of channels CH1 to CHm in parallel. For another example, the storage controller 110 may select the n-th part NVM1n and NVM2n to NVMmn of the non-volatile memory devices, which constitute the n-th way W1n and W2n to Wmn, and may send/receive signals the selected n-th part NVM1n and NVM2n to NVMmn of the non-volatile memory devices through the plurality of channels CH1 to CHm in parallel.

The storage controller 110 may control all the operations of the non-volatile memory devices NVMs. The storage controller 110 may send signals to the channels CH1 to CHm such that the non-volatile memory devices NVM11 to NVMmn connected to the channels CH1 to CHm are controlled independently of each other. For example, the storage controller 110 may send the command CMDa and the address ADDRa to the first channel CH1 such that one selected from the non-volatile memory devices NVM11 to NVM1n is controlled.

Each of the non-volatile memory devices NVM11 to NVMmn may operate under control of the storage controller 110. For example, the non-volatile memory device NVM11 may program the data DATAa based on the command CMDa and the address ADDRa provided to the first channel CH1. For example, the non-volatile memory device NVM21 may read the data DATAb based on the command CMDb and the address ADDRb provided to the second channel CH2 and may send the read data DATAb to the storage controller 110.

An example in which the non-volatile memory devices NVMs communicate with the storage controller 110 through “m” channels and the non-volatile memory devices NVMs include an “n” non-volatile memory device(s) for each channel is illustrated in FIG. 2, but the number of channels and the number of non-volatile memory devices connected to one channel may be variously changed or modified.

An embodiment in which the storage device 100 includes one storage controller 110 and the non-volatile memory devices NVMs is described with reference to FIG. 2, but the scope of the disclosure is not limited thereto. In an embodiment, the storage device 100 may include a plurality of storage controllers, and non-volatile memory devices respectively corresponding to the plurality of storage controllers.

In a case of storing a specific type of data in non-volatile memory devices connected to one channel, the efficiency of reading the data of the non-volatile memory devices may be reduced. In particular, when there is a need to read a large amount of specific-type data, the efficiency may be further reduced. In an embodiment, a type of data may be, for example, a criterion for classifying data as a stream, a key or a value on a key-value structure, a key or a label on a transformer structure, or a weight or a value of a neural network. For example, when the storage controller 110 intends to read first-type data, a manner in which the first-type data are distributed and stored in non-volatile memory devices of the plurality of channels CH1 to CHm may be more efficient to read data than a manner in which the first-type data are stored only in non-volatile memory devices of the first channel CH1 (the reason is that data are capable of being read through a plurality of channels). That is, the non-volatile memory devices NVMs which perform an operation of reading a large amount of specific-type data simultaneously may improve the efficiency of data read, based on distributing and storing data in plural channels.

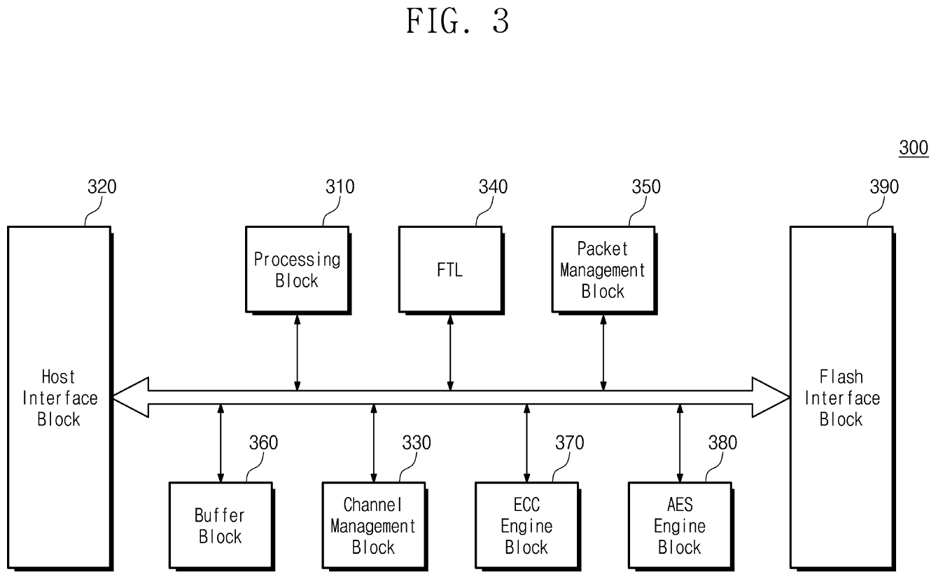

FIG. 3 is a block diagram illustrating an example of a storage controller of FIG. 2, according to one or more example embodiments of the disclosure. A storage controller 300 may correspond to the storage controller 110 of FIG. 2. Referring to FIG. 3, the storage controller 300 may include a processing block 310, a host interface block 320, a channel management block 330, a flash translation layer (FTL) 340, a packet management block 350, a buffer block 360, an error correction code (ECC) engine block 370, an advanced encryption standard (AES) engine block 380, and a flash interface block 390. The storage controller 300 according to one or more example embodiments of the disclosure will be described in detail with reference to FIG. 3.

The processing block 310 may manage all the operations of the storage controller 300. In an embodiment, the processing block 310 may allow the storage controller 300 to perform an operation corresponding to a request received from a host. For example, depending on the request received from the host (e.g., the processor 200 of FIG. 1), the processing block 310 may allow the storage controller 300 to generate a command of the operation corresponding to the request and the address ADDR where the operation is to be performed.

In an embodiment, after the processing block 310 completes the operation corresponding to the request received from the host, the processing block 310 may generate a response indicating that the operation is completed. In an embodiment, the processing block 310 may include one or more processors. For example, the processing block 310 may include a CPU capable of performing plural operations such as an operation of controlling the storage controller 300.

The host interface block 320 may perform communication between the host and the storage controller 300. In an embodiment, the host interface block 320 may receive a request from the host or may send a response to the host. For example, the host interface block 320 may receive a request from the processor 200 of FIG. 1; alternatively, when the storage controller 300 completes an operation corresponding to the request, the host interface block 320 may send, to the processor 200, a response indicating that the operation is completed. In an embodiment, the host interface block 320 may operate under control of the processing block 310.

In an embodiment, the host interface block 320 may transfer the request received from the host to components of the storage controller 300. For example, when the host interface block 320 receives a data write request from the host (e.g., processor 200 in FIG. 2), the host interface block 320 may transfer the received request to the processing block 310 and may transfer data received together with the request to the buffer block 360. In an embodiment, the host interface block 320 may transfer a response, which the processing block 310 generates, to the host (e.g., the processor 200 of FIG. 1).

The channel management block 330 may manage channels in which the data are to be written. In an embodiment, the channel management block 330 may allow the data received by the storage controller 300 to be distributed and stored in the non-volatile memory devices NVMs of FIG. 2. For example, the channel management block 330 may divide or allocate first data, which are received from the storage controller 300 and are to be written in the non-volatile memory devices NVMs, such that a first segment of the first data is written in a non-volatile memory device connected to the first channel CH1 and a second segment of the first data is written in a non-volatile memory device connected to the second channel CH2.

The channel management block 330 may divide data such that type-specific data (or data corresponding to each of a plurality of types) are distributed to two or more channels or may allocate data to a plurality of channels such that type-specific data are distributed to two or more channels. In an embodiment, the channel management block 330 may manage channels in which data (or a segment of data) are to be written (e.g., in a next write operation), for each data type. For example, the channel management block 330 may manage channels in which first-type data (or a segment of data) are to be written; likewise, the channel management block 330 may manage channels in which second-type data (or a segment of data) are to be written (e.g., independently of the first-type data).

For another example, the channel management block 330 may allocate first data of the first type to the first channel CH1 and may allocate second data of the first type to the second channel CH2. Data or a data segment allocated to a plurality of channels may be written in selected non-volatile memory devices connected to the plurality of channels. In an embodiment, segments of data to be written in the non-volatile memory devices NVMs may have the same size. In an embodiment, some of the segments of the data to be written in the non-volatile memory devices NVMs may have different sizes.

In an embodiment, the channel management block 330 may determine channels to which data of a specific type are to be allocated or channels to which segments of the data of the specific type are to be allocated, in various methods. For example, the channel management block 330 may determine channels, in which the first-type data are to be written, depending on a round-robin manner such that the first-type data are sequentially allocated to a plurality of channels. In an embodiment, the first-type data may be sequentially written in selected non-volatile memory devices respectively connected to the plurality of channels.

The description is given as the channel management block 330 selects channels, to which data are to be allocated, in the round-robin manner; however, this is provided as an example, and the scope of the disclosure is not limited thereto. In an embodiment, the channel management block 330 may select an arbitrary channel determination manner in which data are allocated to all of the plurality of channels or some of the plurality of channels. In an embodiment, the channel management block 330 may allocate data of each of a plurality of types to all the channels (or a plurality of channels). The data of each of the plurality of types may be distributed and stored in non-volatile memory devices respectively connected to all the channels (or the plurality of channels). When data remain even after data of a specific type are allocated to all the channels, the channel management block 330 may allocate the remaining data to all the channels (or the plurality of channels) in the same manner.

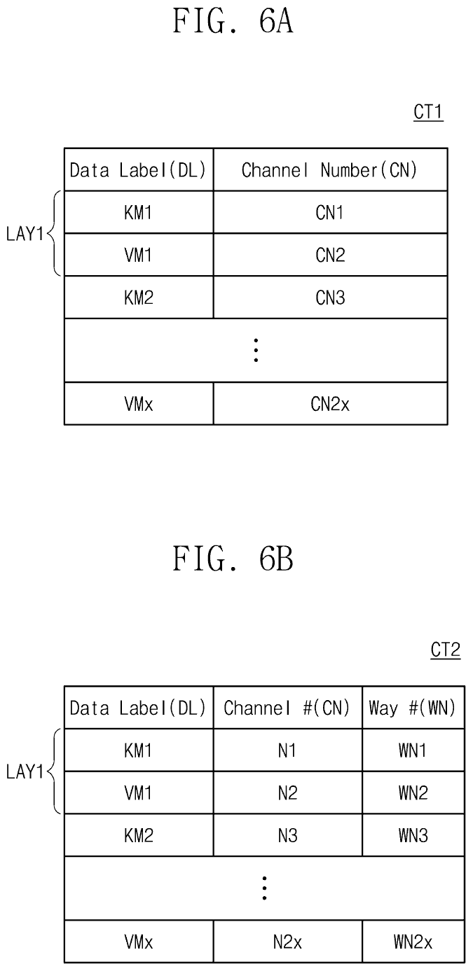

The channel management block 330 may manage a channel, in which data (or a data segment) are to be written in an arbitrary manner, for each type. In an embodiment, the channel management block 330 manage a relationship between types of data and a next channel, in which data corresponding to types are to be written, based on a table structure. The description will be given based on an embodiment in which the channel management block 330 manages next channels, in which data are to be written, based on the table structure, but the scope of the disclosure is not limited thereto. For example, it should be understood that an embodiment in which the relationship therebetween is managed through an arbitrary data structure also belongs to the scope of the disclosure. How the channel management block 330 manages next channels, in which data (or a data segment) are to be written for each type of data will be described with reference to FIGS. 6A and 6B.

The FTL 340 may perform various functions such as address mapping, wear leveling, or garbage collection. The address mapping may refer to an operation of translating a logical address received from the host (e.g., the processor 200) into a physical address of the non-volatile memory devices NVMs, at which data are actually stored or may refer to a reverse operation thereto. The wear leveling may refer to a technology for allowing blocks in the non-volatile memory devices NVMs to be used uniformly such that excessive degradation of a specific block is prevented. In an embodiment, the FTL 340 may implement the wear leveling, based on a firmware technology for balancing erase counts of physical blocks.

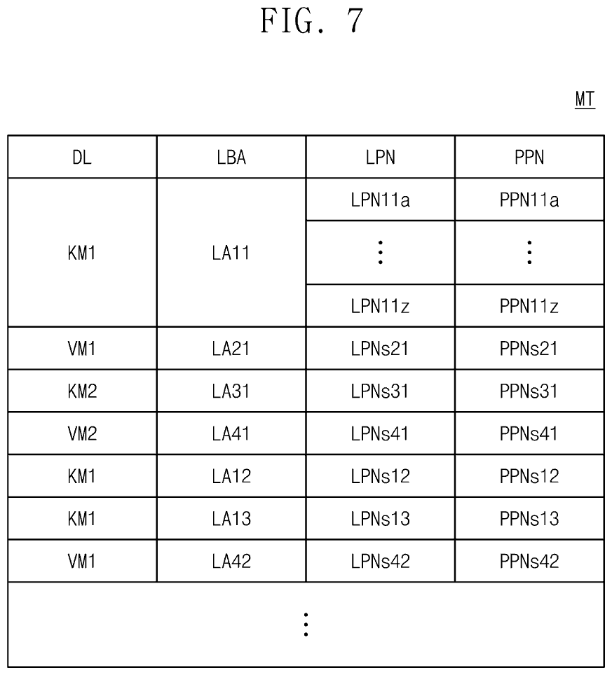

The garbage collection refers to a technology for securing an available capacity of the non-volatile memory devices NVMs through a way to erase an existing block after copying valid data of the existing block to a new block. In an embodiment, the FTL 340 may be implemented by an OS or firmware. In an embodiment, the FTL 340 may use a mapping table to perform the address mapping, but one or more example embodiments of the disclosure is not limited thereto. For example, it should be understood that an embodiment in which the address mapping is performed based on an arbitrary data structure also belongs to the scope of the disclosure. The mapping table will be described in detail with reference to FIG. 7.

The packet management block 350 may generate a packet in compliance with a protocol of an interface agreeing with the host (e.g., the processor 200 of FIG. 1) or may parse various kinds of information from the packet received from the host. Also, the buffer block 360 may temporarily store data to be written in the non-volatile memory devices NVMs or data read from the non-volatile memory devices NVMs. In an embodiment, the buffer block 360 may include a volatile memory such as an SRAM or a DRAM. In an embodiment, the buffer block 360 may further include a non-volatile memory such as a NAND flash memory. In FIG. 3, the description is given based on an embodiment in which the storage controller 300 includes the buffer block 360, but it should be understood that an embodiment in which the buffer block 360 is provided outside the storage controller 300 also belongs to the scope of the disclosure.

The ECC engine block 370 may perform an error detection and correction function on the read data read from the non-volatile memory devices NVMs. In an embodiment, the ECC engine block 370 may generate parity bits of data to be written in the non-volatile memory devices NVMs. In an embodiment, the generated parity bits may be stored in the non-volatile memory devices NVMs together with the write data. In an embodiment, when data are read from the non-volatile memory devices NVMs, the ECC engine block 370 may correct an error of the read data by using the parity bits read from the non-volatile memory devices NVMs together with the read data and may output the error-corrected read data. The description is given based on an embodiment in which the ECC engine block 370 corrects an error of data by using the parity bits, but it should be understood that an embodiment in which an error of data is corrected based on any other manner also belongs to the scope of the disclosure.

The AES engine block 380 may perform at least one of an encryption operation and a decryption operation on data input to the storage controller 300. In an embodiment, the AES engine block 380 may perform the encryption operation or the decryption operation by using a symmetric-key algorithm. The flash interface block 390 may provide the non-volatile memory devices NVMs with data to be written in the non-volatile memory devices NVMs or may receive data read from the non-volatile memory devices NVMs. In an embodiment, the flash interface block 390 may transfer a command(s) or an address(es) to the non-volatile memory devices NVMs. In an embodiment, the flash interface block 390 may be implemented to comply with a protocol such as Toggle or an open NAND flash interface (ONFI).

The respective blocks described with reference to FIG. 3 may be functionally distinguished from each other, and the scope of the disclosure is not limited thereto. Also, it should be understood that an embodiment in which a function of each block is performed by any other block also belongs to the scope of the disclosure. For example, it should be understood that an embodiment in which the processing block 310 performs the functions of the channel management block 330, the FTL 340, the packet management block 350, or the ECC engine block 370 also belongs to the scope of the disclosure.

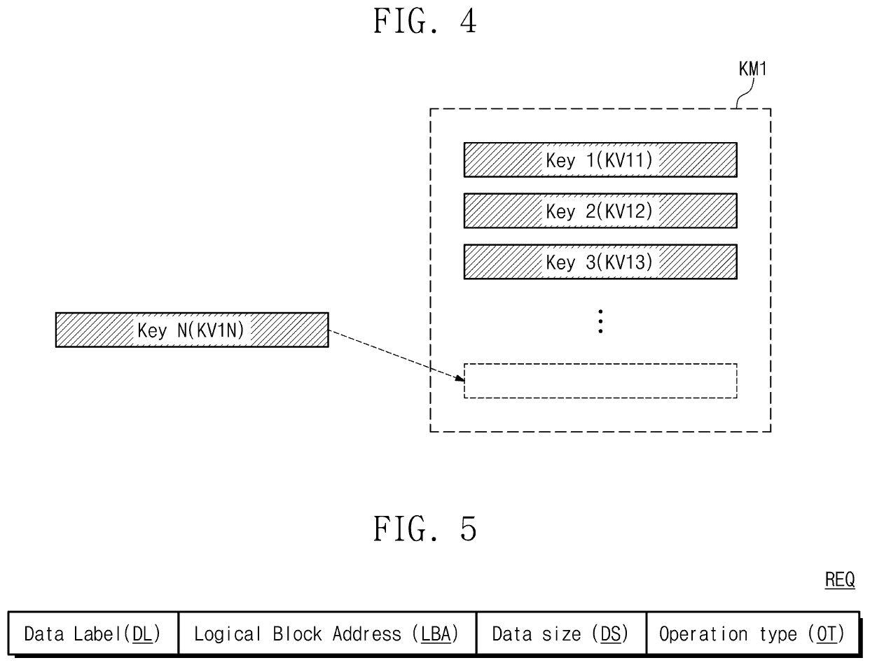

FIG. 4 is a diagram illustrating an example of a form in which the processor 200 of FIG. 1 writes and reads data, according to one or more example embodiments of the disclosure. In an embodiment, the processor 200 of FIG. 1 may implement the transformer structure and may have a data write and read form according to FIG. 4. According to one or more example embodiments of the disclosure, an example of writing and reading data to implement the artificial intelligence model will be described with reference to FIG. 4.

Referring to FIG. 4, 11th to 1N-th key vectors KV11 and KV12 to KV1N and a first key matrix KM1 are illustrated. In an embodiment, a key vector and a key matrix may be data belonging to a key among a query, a key, and a value which are used on a transformer structure. In an embodiment, the key matrix may include a plurality of key vectors. For example, the first key matrix KM1 may include the 11th key vector KV11, the 12th key vector KV12, and the 13th key vector KV13.

In an embodiment, the key matrix may be generated based on concatenating a plurality of key vectors sequentially. For example, the first key matrix KM1 may be generated based on concatenating the 11th key vector KV11 to the 1N-th key vector KV1N sequentially. Referring to FIGS. 1 to 3 together, in an embodiment, the processor 200 may generate the key matrix, based on sequentially storing the generated key vector in the storage device 100.

The key vectors may be generated based on computation in the processor 200. In an embodiment, the key vectors may be generated based on a weight calculation of the processor 200. For example, the key vectors may be generated based on a multiplication or matrix multiplication calculation between a weight vector (or a weight matrix) and a key matrix. In an embodiment, the processor 200 may generate a new key vector, based on the weight calculation of the key matrix generated through the sequential concatenation of the key vectors.

In an embodiment, the processor 200 may write each of the generated key vectors on the storage device 100. In an embodiment, the processor 200 may read the key matrix generated through the sequential concatenation of the generated key vectors and may generate a next (or new) key vector by performing the weight calculation based on the read key matrix. In FIG. 4, the description is given based on the key vector and the key matrix, but the scope of the disclosure is not limited thereto. For example, it should be understood that a value vector and a value matrix are also generated and managed in the same manner. That is, the value matrix may be generated through the sequential concatenation of value vectors, and the processor 200 may write the value vector in the storage device 100 and may read the value matrix generated through the sequential concatenation of the value vectors from the storage device 100.

The size of data which the processor 200 writes in the storage device 100 (e.g., simultaneously) may be different from the size of data which the processor 200 reads from the storage device 100 (e.g., simultaneously). Accordingly, in a case where all the data of the key matrix are stored in one channel of the non-volatile memory devices NVMs of FIG. 2, the performance of read operation may be reduced compared to a case where data of the key matrix are distributed and stored in a plurality of channels of the non-volatile memory devices NVMs, thereby causing the reduction of performance of the processor 200 implementing the artificial intelligence model.

An embodiment in which data are efficiently stored in the storage device 100 to implement the transformer structure, an embodiment in which the processor 200 reads data to implement the transformer structure, and an embodiment of the storage device 100 for implementation of the transformer structure will be described in detail with reference to the following drawings.

FIG. 5 is a diagram illustrating an example of a request transmitted by a processor of FIG. 1 to a storage device, according to one or more example embodiments of the disclosure. Referring to FIG. 5, a request REQ may include a data label DL, a logical block address LBA, a data size DS, and an operation type OT. A request transmitted by the processor 200 to the storage device 100 will be described in detail with reference to FIG. 5.

Referring to FIGS. 1 to 4 together, the data label DL may indicate a kind of data which are exchanged between the processor 200 and the storage device 100. In an embodiment, the data label DL may indicate a type of data to be written in the storage device 100 or a type of data to be read from the storage device 100. In an embodiment, the data type may be a query, a key, or a value described with reference to FIGS. 1 to 4. For example, when data to be written in the storage device 100 are included in the first key matrix KM1, the data label DL may indicate that the data to be written are a key vector of the first key matrix KM1. An example of the data label DL will be described in detail with reference to FIGS. 6A, 6B, and 7.

The logical block address LBA may be an address of a storage space which the processor 200 manages. In an embodiment, the logical block address LBA may be an address which the processor 200 uses to access the storage device 100. In an embodiment, the logical block address LBA may indicate a start logical address of data which the processor 200 stores in the storage device 100. The data size DS may indicate the size of data to be written in the storage device 100 or the size of data to be read from the storage device 100. In an embodiment, the data size DS may be an integer multiple of a data size by which one write operation or one read operation is capable of being performed.

The operation type OT may indicate an operation corresponding to the request REQ. For example, when the request REQ indicates an operation of reading data stored in the storage device 100, the operation type OT may indicate the read operation. For another example, when the request REQ indicates an operation of writing data in the storage device 100, the operation type OT may indicate the write operation or the data write operation.

The request REQ may be implemented by a combination of bits having an arbitrary length. In an embodiment, after the request REQ, the processor 200 may transfer data corresponding to the request REQ to the storage device 100. The data label DL, the logical block address LBA, the data size DS, and the operation type OT included in the request REQ are provided as an example, and the scope of the disclosure is not limited thereto. It should be understood that an embodiment in which the request REQ does not include some of the data label DL, the logical block address LBA, the data size DS, or the operation type OT also belongs to the scope of the disclosure. It should be understood that an embodiment in which the request REQ includes the data label DL, the logical block address LBA, the data size DS, and the operation type OT in an arbitrary order also belongs to the scope of the disclosure.

FIGS. 6A and 6B are diagrams illustrating channel tables CT1 and CT2 which a storage controller of FIG. 2 manages, according to one or more example embodiments of the disclosure. A first channel table CT1 and a second channel table CT2 may indicate channels through which next data are to be transmitted for respective data types. Referring to FIG. 6A, the first channel table CT1 may include mapping between the data label DL and a channel number CN. Referring to FIG. 6B, the second channel table CT2 may include mapping between the data label DL, the channel number CN, and a way number WN. A page mapping table according to one or more example embodiments of the disclosure will be described with reference to FIGS. 1, 6A, and 6B.

The channel tables CT1 and CT2 may manage channels, to which data are to be transmitted, in a next write operation for each data label. In an embodiment, each of the first and second channel tables CT1 and CT2 may manage channels, in which data are to be written through one program operation, for each data label. In an embodiment, the first and second channel tables CT1 and CT2 may change the channel number CN corresponding to the data label DL after the data write operation of the storage controller 300. In an embodiment, when data to be written require a plurality of program operations, the storage controller 300 may distribute and write the data in a plurality of channels, and after the program operation, the storage controller 300 may change channel mapping of the first and second channel tables CT1 and CT2 to be set to the channel number CN at which the data are to be written.

For example, when the storage controller 300 writes the key vector of the first key matrix KM1 in the non-volatile memory devices NVMs through one program operation, the storage controller 300 may perform the data program operation on a non-volatile memory device connected to a CN1-th channel number CN1. In this case, the storage controller 300 may change the channel number CN corresponding to the first key matrix KM1 of the first and second channel tables CT1 and CT2 to a number of a channel where a next write operation is to be performed. For another example, when the storage controller 300 writes one value vector of a first value matrix VM1 in non-volatile memory devices through four program operations, the storage controller 300 may program one value vector in four non-volatile memory devices respectively connected to four channels including an N2-th channel N2. In this case, after the storage controller 300 completes the write operation, the storage controller 300 may change the channel number CN corresponding to the first value matrix VM1 of the channel tables CT1 and CT2 to a number of a channel where a next write operation is to be performed.

In an embodiment, a key matrix and a value matrix corresponding to the key matrix may be included in one layer. For example, a first layer LAY1 may include the first key matrix KM1 and the first value matrix VM1. For another example, a second layer may include a second key matrix KM2 and a second value matrix VM2.

In an embodiment, the storage controller 300 may manage the channel tables CT1 and CT2 such that data for each data type are distributed and programmed in all (or some) of a plurality of channels. For example, when the storage controller 300 controls the non-volatile memory devices NVMs connected to four channels and writes data in the non-volatile memory devices NVMs through five program operations, the storage controller 300 may perform the program operations on the non-volatile memory devices respectively connected to the first to fourth channels and may perform the program operation on the non-volatile memory device connected to one arbitrary channel among the first to fourth channels. In an embodiment, when the storage controller 300 writes data in the non-volatile memory devices NVMs, based on a plurality of program operations, the storage controller 300 may complete the data write process by repeating an update of the channel tables CT1 and CT2 plural times each time one program operation is performed.

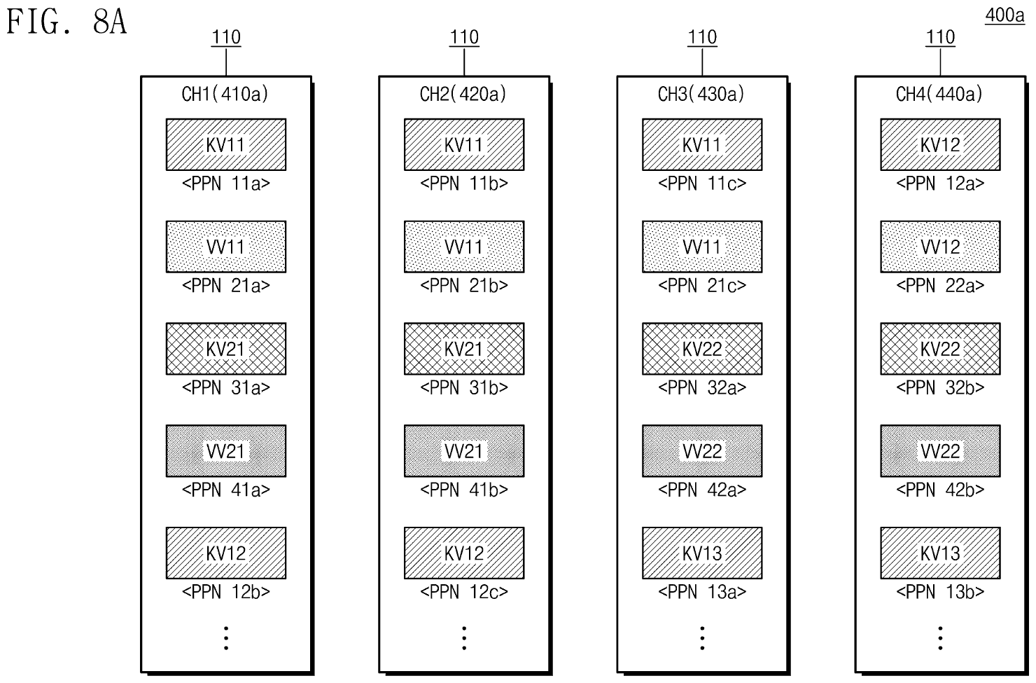

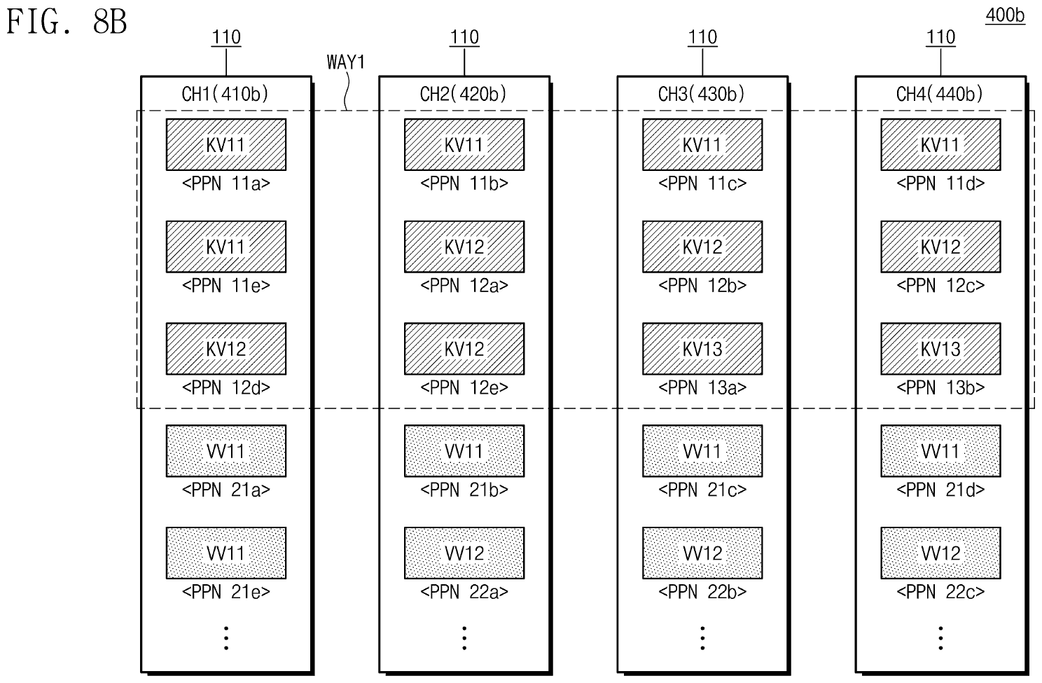

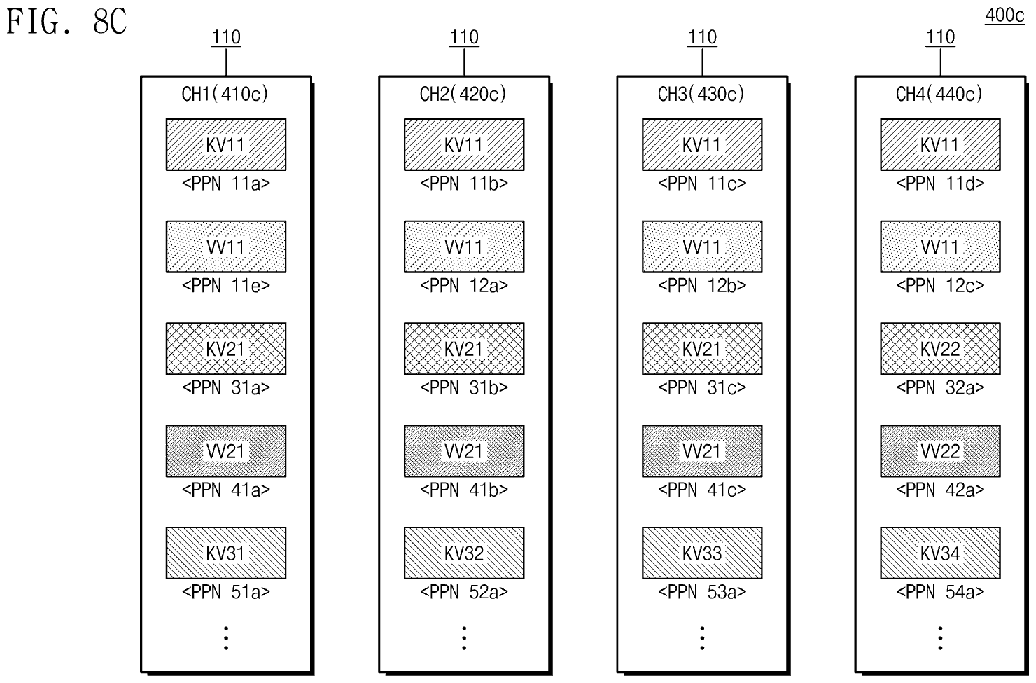

In an embodiment, the storage controller 300 may update a channel number of the channel tables CT1 and CT2, based on various manners. For example, the storage controller 300 may update channel numbers, at which a next program operation is to be performed, in a manner of sequentially increasing a channel number of each data label DL (e.g., after the storage controller 300 performs the program operation on a non-volatile memory device connected to the last channel number, the storage controller 300 may update the channel tables CT1 and CT2 such that a channel number is changed to the first channel number). For another example, the storage controller 300 may update the channel number CN of each data label DL in a random manner such that data are distributed and sent to all the channels. (In this case, after data are written in non-volatile memory devices respectively connected to all the channels, the storage controller 300 may select a channel to allocate or send data in the same manner). An operation in which the storage controller 300 writes data by utilizing the channel tables CT1 and CT2 will be described with reference to FIGS. 8A to 8C.

In an embodiment, the channel tables CT1 and CT2 may further include information about a path through which data are sent, in addition to the channel information. For example, referring to FIG. 6B, the second channel table CT2 may further include a relationship between the data labels DL and a way which non-volatile memory devices to which data are to be transmitted constitute. That is, the storage controller 300 may manage a channel, to which data are to be allocated or sent, for each data type and a way, which non-volatile memory devices to which data are to be transmitted constitute, for each data type, by utilizing the second channel table CT2 of FIG. 6B. (The storage controller 300 may select a non-volatile memory device to write data by referring to way information.) In an embodiment, the storage controller 300 may store data, to which the same data label DL is given, in non-volatile memory devices constituting the same way (e.g., based on the second channel table CT2). The way number WN of the second channel table CT2 may indicate a way which non-volatile memory devices to be selected by the storage controller 300 constitute.

The description is given based on that the second channel table CT2 further includes a relationship between the data label DL and a way to which data are to be transmitted, but the scope of the disclosure is not limited thereto. For example, in addition to the relationship of the first channel table CT1, the second channel table CT2 may further include a relationship between the data label DL and a way to which data are to be transmitted, a relationship between the data label DL and a plane to which data are to be transmitted, and/or a relationship between the data label DL and a die to which data are to be transmitted.

In an embodiment, the storage controller 300 may include only one of the channel tables CT1 and CT2 described with reference to FIGS. 6A and 6B. In an embodiment, the storage controller 300 may manage the channel tables CT1 and CT2 through the channel management block 330. In an embodiment, the storage controller 300 may manage the channel tables CT1 and CT2 through the processing block 310 or the FTL 340.

FIG. 7 is a diagram illustrating an example of a mapping table which the FTL of FIG. 3 manages, according to one or more example embodiments of the disclosure. Referring to FIG. 7, a mapping table MT may include a mapping relationship between the data label DL, the logical block address LBA, a logical page number LPN, and a physical page number PPN.

The mapping table MT may include a mapping relationship between a logical block address and a logical page number, which the host manages, and a physical page number indicating a physical storage location of the non-volatile memory devices NVMs. In an embodiment, the mapping table MT may further include a relationship between the data label DL and the logical block address LBA. For example, referring to FIG. 7, data of the first key matrix KM1 may be stored at a 11th logical address LA11 and a 12th logical address LA12, and the 11th logical address LA11 may include 11a-th to 11z-th logical page numbers LPN11a to LPN11z. In an embodiment, the 11a-th to 11z-th logical page numbers LPN11a to LPN11z may respectively correspond to 11a-th to 11z-th physical page numbers PPN11a to PPN11z. In an embodiment, a physical page corresponding to a physical page number may refer to a unit by which data are written through one program operation.

The mapping table MT may be managed by the FTL 340 of FIG. 3. In an embodiment, the FTL 340 may update the mapping table MT depending on the operation of the storage controller 300. For example, the FTL 340 may update and manage the mapping table MT in addition to the address mapping operation, the wear leveling operation, or the garbage collection operation. In an embodiment, the mapping table MT may be referenced when the storage controller 300 generates the command CMD or the address ADDR.

In FIG. 7, it should be understood that the number of logical page numbers corresponding to one logical address and the number of physical page numbers corresponding to one logical address may be determined arbitrarily. The mapping table MT of FIG. 7 is provided as an example, and the scope of the disclosure is not limited thereto.

FIGS. 8A to 8C are block diagrams illustrating the form in which a memory device including a plurality of channels stores data, according to one or more example embodiments of the disclosure. According to the disclosure, an embodiment in which data are distributed and stored in a plurality of channels will be described with reference to FIGS. 1 to 7 and 8A to 8C. In FIGS. 8A to 8C, data belonging to the same data label DL are shaded in the same manner. In FIGS. 8A to 8C, the data belonging to the first key matrix KM1 are shaded by a left diagonal line, and the data belonging to the first value matrix VM1 are shaded in gray. The data belonging to the second key matrix KM2 are shaded by a lattice pattern, and the data belonging to the second value matrix VM2 are shaded in black. The data belonging to the third key matrix KM3 are shaded by a right diagonal line. In FIGS. 8A, 8B, and 8C, each key vector or each value vector will be described as having an arbitrary data size or an arbitrary data length, but this is provided as an example for convenience of description. It should be understood that the scope of the disclosure is not limited thereto. In FIGS. 8A to 8C, the form where data are stored in each channel is illustrated, but this is provided for convenience of description. It should be understood that data are stored in non-volatile memory devices connected to a channel.

In an embodiment, in a key matrix and a value matrix belonging to the same layer, a key vector and a value vector may have the same data size (or length). For example, the first layer may include the first key matrix KM1 and the first value matrix VM1, the first key matrix KM1 may include the 11th key vector KV11, the first value matrix VM1 may include the 11th value vector VV11, and the 11th key vector KV11 and the 11th value vector VV11 may have the same data size (or length). In an embodiment, in a key matrix and a value matrix belonging to the same layer, a key vector and a value vector may have different data sizes (or lengths). Below, the description will be given under the condition that a key vector and a value vector in the same layer have the same data size (or length), but the scope of the disclosure is not limited thereto.

In an embodiment, each of key vectors or value vectors may be distributed and stored in non-volatile memory devices respectively connected to channels in the form of one or more segments. In an embodiment, the segments of the data distributed and stored in respective channels may include information for restoring the data. For example, segments of each (key or value) vector distributed and stored in respective channels may include information (or index) for restoring the (key or value) vector. In an embodiment, segments of each (key or value) vector distributed and stored in respective channels may include information for restoring a (key or value) matrix. For example, referring to FIG. 8A, segments of the 11th key vector KV11 respectively stored in first to third channels 410a, 420a, and 430a may include information or an index for the formation to the first key matrix KM1. (In this case, segments of a key vector sequentially read may be used as a portion of the first key matrix KM1 by the data manager 210 of the processor 200).

Referring to FIGS. 1 to 7 and 8A, a memory device 400a may include the first channel 410a, the second channel 420a, the third channel 430a, and a fourth channel 440a, and each of the channels 410a to 440a may include a plurality of non-volatile memory devices. The memory device 400a may be the same as or similar to the non-volatile memory devices NVMs of FIG. 2.

In FIG. 8A, the data size (or length) of a key vector of the first key matrix KM1 may correspond to three physical pages. Likewise, the data size (or length) of a value vector of the first value matrix VM1 may correspond to three physical pages. Each of the data size (or length) of a key vector of the second key matrix KM2 and the data size (or length) of a value vector of the second value matrix VM2 may correspond to two physical pages.

In an embodiment, before the storage controller 300 writes data in the memory device 400a for the first time, all the channels corresponding to the data labels DL of the first channel table CT1 which the storage controller 300 or the channel management block 330 manages may indicate the first channel 410a. When the storage controller 300 receive a data write request REQ for the 11th key vector KV11 from the processor 200, the storage controller 300 may start the program operation from the first channel 410a by referring to the first channel table CT1.

Because the size of the 11th key vector KV11 corresponds to three physical pages, the storage controller 300 may allocate the data of the 11th key vector KV11 to three channels including the first channel 410a (e.g., through the channel management block 330). For example, the storage controller 300 may allocate the 11th key vector KV11 to the first channel 410a, the second channel 420a, and the third channel 430a. The storage controller 300 may write the data of the 11th key vector KV11 at physical pages respectively included in the first channel 410a, the second channel 420a, and the third channel 430a. (In FIG. 8A, the inside of parentheses < > may indicate the physical page number PPN corresponding to a key vector). After the storage controller 300 writes the data of the 11th key vector KV11, the storage controller 300 may change the channel corresponding to the first key matrix KM1 to the fourth channel 440a.

Next, based on a request received from the processor 200, the storage controller 300 may write data of the same type or data of another type in the memory device 400a. For example, when the processor 200 sends the write request REQ for the 11th value vector VV11 included in the first value matrix VM1 to the storage controller 300, the storage controller 300 may generate commands, addresses, and data to be sent to respective channels by referring to channels corresponding to the first value matrix VM1 of the first channel table CT1. The storage controller 300 may allocate the 11th value vector VV11 to three channels including the first channel 410a. The storage controller 300 may write the 11th value vector VV11 in the first channel 410a, the second channel 420a, and third channel 430a, and after the write operation is completed, the storage controller 300 may update the first channel table CT1 such that the channel corresponding to the first value matrix VM1 is changed to the fourth channel 440a.

Then, the storage controller 300 may receive the write request for the 21st key vector KV21 belonging to the second key matrix KM2 from the processor 200. The storage controller 300 may write the data of the 21st key vector KV21 from a non-volatile memory device connected to the first channel 410a by referring to the first channel table CT1. Because the length of the 21st key vector KV21 corresponds to two physical pages, the storage controller 300 may distribute and write the 21st key vector KV21 in non-volatile memory devices connected to the first channel 410a and the second channel 420a and may update the first channel table CT1 such that the channel corresponding to the second key matrix KM2 is changed to the third channel 430a. Likewise, the storage controller 300 may write all of the 22th key vector KV22, the 21st value vector VV21, and the 22nd value vector VV22 in the memory device 400a. (After all of the 22th key vector KV22, the 21st value vector VV21, and the 22nd value vector VV22 are completely written, the first channel table CT1 may be updated such that channels corresponding to the second key matrix KM2 and the second value matrix VM2 are changed to the first channel 410a).

Afterwards, the storage controller 300 may write the 12th key vector KV12 included in the first key matrix KM1 in the memory device 400a. By referring to the first channel table CT1, the storage controller 300 may start to write data from a non-volatile memory device of the fourth channel 440a and may then write data in non-volatile memory devices of the first channel 410a and the second channel 420a. The storage controller 300 may update the first channel table CT1 such that the channel corresponding to the first key matrix KM1 is changed to the third channel 430a (e.g., through the channel management block 330).

In an embodiment, data of the same type may be stored in a region with the same physical characteristic. For example, referring to FIGS. 2 and 8A together, data of the same type may be stored in non-volatile memory devices with the same way number. In detail, for example, the 11th key vector KV11, the 12th key vector KV12, and the 13th key vector KV13 included in the first key matrix KM1 may be stored in non-volatile memory devices constituting the first way.

Referring to FIGS. 1 to 7 and 8B, a memory device 400b may include a first channel 410b, a second channel 420b, a third channel 430b, and a fourth channel 440b, and each of the channels 410b to 440b may include a plurality of non-volatile memory devices. The memory device 400b may be the same as or similar to the non-volatile memory devices NVMs of FIG. 2.

Unlike FIG. 8A, in FIG. 8B, each of key vectors of the first key matrix KM1 may have a data size or a data length corresponding to five physical pages. In FIG. 8B, before the storage controller 300 starts to write data in the memory device 400b, a channel in which the data label DL of the first layer LAY1 in the first channel table CT1 corresponds to the first key matrix KM1 and the first value matrix VM1 may be the first channel 410b.

The storage controller 300 may receive the write operation request for the 11th key vector KV11 included in the first key matrix KM1. As a response to the request, the storage controller 300 may generate commands, and addresses associated with the write operation of the 11th key vector KV11 by referring to the first channel table CT1 (and the mapping table MT). The storage controller 300 may write segments of the 11th key vector KV11 in non-volatile memory devices of the first to fourth channels 410b, 420b, 430b, and 440b and may write the last segment of the 11th key vector KV11 in a non-volatile memory device of the first channel 410b. In this case, the storage controller 300 may update the first channel table CT1 such that the channel corresponding to the first key matrix KM1 is changed to the second channel 420b.

Afterwards, the storage controller 300 may write the 12th key vector KV12 and the 13th key vector KV13. After the storage controller 300 writes the 12th key vector KV12, the storage controller 300 may update the first channel table CT1 such that the channel corresponding to the first key matrix KM1 is changed to the third channel 430b. After the storage controller 300 writes the 13th key vector KV13, the storage controller 300 may update the first channel table CT1 such that the channel corresponding to the first key matrix KM1 is changed to the fourth channel 440b. (Only two of segments of the 13th key vector KV13 are illustrated in FIG. 8B, but it should be understood that the remaining segments are distributed and stored in non-volatile memory devices of the first to third channels 410b to 430b).

In an embodiment, key vectors included in the first key matrix KM1 may be stored non-volatile memory devices sharing a physical characteristic. For example, the 11th key vector KV11, the 12th key vector KV12, and the 13th key vector KV13 may be distributed and stored in non-volatile memory devices constituting the first way.

Like the key vectors of the first key matrix KM1, the storage controller 300 may write the 11th value vector VV11 and the 12th value vector VV12 of the first value matrix VM1 in the memory device 400b. After the storage controller 300 completely stores the 11th value vector VV11 and the 12th value vector VV12, the storage controller 300 may update the first channel table CT1 such that the channel corresponding to the first value matrix VM1 is changed to the second channel 420b and then is changed to the third channel 430b.

Referring to FIGS. 1 to 7 and 8C, a memory device 400c may include a first channel 410c, a second channel 420c, a third channel 430c, and a fourth channel 440c, and each of the channels 410c to 440c may include a plurality of non-volatile memory devices. A plurality of non-volatile memory devices may be connected to a channel through a plurality of ways connected to at least one non-volatile memory device. The memory device 400c may be the same as or similar to the non-volatile memory devices NVMs of FIG. 2.

Unlike FIGS. 8A and 8B, in FIG. 8C, each of key vectors of the first key matrix KM1 may have a data size or a data length corresponding to four physical pages. Likewise, each of value vectors of the first value matrix VM1 may have a data size or a data length corresponding to four physical pages. In the second key matrix KM2 and the second value matrix VM2, each vector may have a data size or a data length corresponding to three physical pages. Each vector of the third key matrix KM3 may have a data size or a data length corresponding to one physical page. The first key matrix KM1, the first value matrix VM1, the second key matrix KM2, and the second value matrix VM2 may be distributed and stored in the channels 410c to 440c to be the same as or similar to the method described with reference to FIGS. 8A and 8B.

The storage controller 300 may store the 31th key vector KV31 of the third key matrix KM3 in the memory device 400c. The storage controller 300 may write the 31st key vector KV31 in a non-volatile memory device of the first channel 410c, based on that the channel corresponding to the third key matrix KM3 of the first channel table CT1 is the first channel 410c After the storage controller 300 completely writes the 31st key vector KV31, the storage controller 300 may change the channel corresponding to the third key matrix KM3 to the second channel 420c. Likewise, the storage controller 300 may write the 32nd key vector KV32, the 33th key vector KV33, and the 34th key vector KV34 in a non-volatile memory device of the second channel 420c, a non-volatile memory device of the third channel 430c, and a non-volatile memory device of the fourth channel 440c, respectively. After the storage controller 300 completely writes the 32th key vector KV32, the storage controller 300 may change the channel corresponding to the third key matrix KM3 to the third channel 430c; finally, after the storage controller 300 completely writes the 34th key vector KV34, the storage controller 300 may change the channel corresponding to the third key matrix KM3 to the first channel 410c.

The storage controller 300 which writes data by using the method of FIGS. 8A, 8B, and 8C may read an arbitrary type of data by utilizing all of the plurality of channels. For example, when the storage controller 300 receives the read request of the first key matrix KM1 from the processor 200, the storage controller 300 may read data more quickly by utilizing all the channels. The storage controller 300 which writes data by using the method of FIGS. 8A, 8B, and 8C may read data for each type more quickly than a method of storing one type of data in one physical space. In particular, when the processor 200 implements a transformer structure in which the size of the read data is significantly larger than the size of the write data, the storage controller 300 which writes data by using the method of FIGS. 8A, 8B, and 8C may provide data to the processor 200 of FIG. 1 efficiently and quickly. In this case, the processing unit 200 may implement a model (e.g., artificial intelligence model) including the transformer structure more quickly.

In FIGS. 8A, 8B, and 8C, the order of writing data is provided as an example, and the scope of the disclosure is not limited thereto. It should be understood that an embodiment in which data are written in an order different from the above order also belongs to the scope of the disclosure. In FIGS. 8A, 8B, and 8C, the description is given based on a manner in which the storage controller 300 updates the channel number CN of the first channel table CT1 in the round-robin manner, but the scope of the disclosure is not limited thereto. In an embodiment, it should be understood that an embodiment in which data of each data type are distributed and stored in all or some of a plurality of channels based on that the storage controller 300 selects a next channel(s) to write data in an arbitrary manner and updates the channel number CN for each data label DL in a channel table also belongs to the scope of the disclosure. An operation in which the storage controller 300 allocates data to be written to channels by referring to a channel table, an operation in which the storage controller 300 generates commands or addresses to be sent to respective channels, and an operation in which the storage controller 300 divides or generates data to be sent to respective channels may be performed at the same time, or at least some thereof may be performed to overlap each other.

In FIGS. 8A, 8B, and 8C, an embodiment in which a plurality of segments of each (key or value) vector are distributed and stored in channels and the first channel table CT1 is updated such that a channel is changed to a channel of a non-volatile memory device where next data are to be written is described, but the scope of the disclosure is not limited thereto. In an embodiment, the storage controller 300 may write one segment of each (key or value) vector in a non-volatile memory device of one channel, may then update the first channel table CT1, and may then write a next segment in a non-volatile memory device of a next channel by referring to the updated first channel table CT1. In FIGS. 8A, 8B, and 8C, the description is given based on an embodiment in which the number of channels which the memory device 400a/400b/400c includes “4”, but the scope of the disclosure is not limited thereto. For example, it should be understood that an embodiment in which the memory device 400a/400b/400c includes the arbitrary number of channels also belongs to the scope of the disclosure.

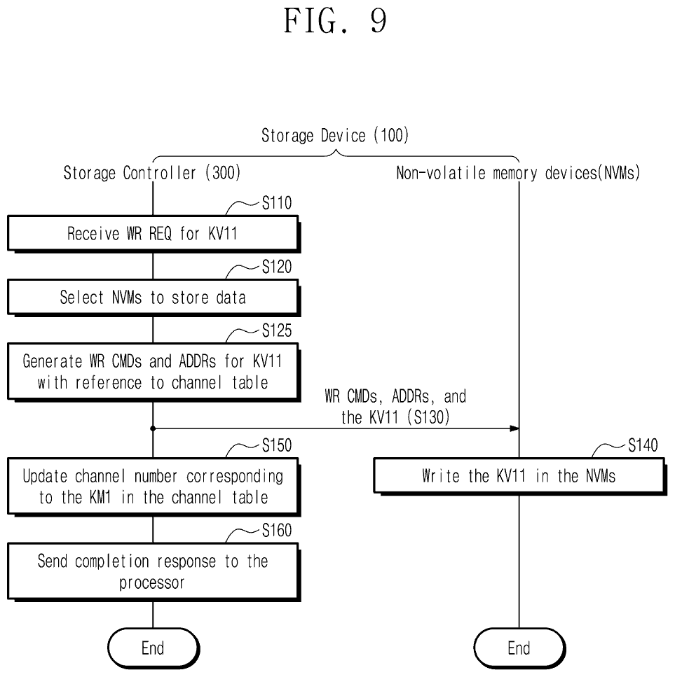

FIG. 9 is a flowchart illustrating an operation method of a storage device of FIGS. 1 to 8C, according to one or more example embodiments of the disclosure. A data write operation according to one or more example embodiments of the disclosure will be described in detail with reference to FIGS. 1 to 9.

In operation S110, the storage controller 300 may receive a request. In an embodiment, the request received by the storage controller 300 may be the same as or similar to the request REQ of FIG. 5. For example, the storage controller 300 may receive the write request of the 11th key vector KV11 including the operation type OT of the write operation and the data label DL of the first key matrix KM1. In an embodiment, the storage controller 300 may receive the write request from the processor 200.

In operation S120, the storage controller 300 may select non-volatile memory devices to store data. In an embodiment, the storage controller 300 may select non-volatile memory devices constituting the same way. For example, referring to FIGS. 2 and 9 together, the storage controller 300 may select an n-th part of non-volatile memory devices NVM1n and NVM2n to NVMmn constituting the n-th way W1n and W2n to Wmn.

In an embodiment, the storage controller 300 may determine non-volatile memory devices to select, based on the data label DL. In an embodiment, the storage controller 300 may select non-volatile memory devices constituting one way, based on the data label DL. In detail, for example, when the storage controller 300 writes data of the first key matrix KM1, the storage controller 300 may select a first part of non-volatile memory devices NVM11 and NVM21 to NVMm1 constituting a first way W11 and W21 to Wm1.

In an embodiment, the storage controller 300 may manage a relationship between the data label DL and a way which non-volatile memory devices to select constitute. For example, through the second channel table CT2 of FIG. 6B, the storage controller 300 may manage a relationship between the data label DL and a way which non-volatile memory devices to select constitute. For another example, the storage controller 300 may generate information about the relationship between the data label DL and the way which non-volatile memory devices to select constitute through the processing block 310 and may store and use the relationship information in the buffer block 360.

The information about the relationship between the data label DL and the way which non-volatile memory devices to select constitute may be stored in an arbitrary data structure. In an embodiment, the information about the relationship between the data label DL and the way which non-volatile memory devices to select constitute may be stored in the form of a table. For example, the second channel table CT2 may include the information about the relationship between the data label DL and the way which non-volatile memory devices to select constitute.

In operation S125, the storage controller 300 may generate commands and addresses for writing the 11th key vector KV11. In an embodiment, the storage controller 300 may determine the numbers of commands and addresses to be generated, based on the data size DS included in the request and the size of a physical page of each non-volatile memory device. For example, referring to FIGS. 8a and 9 together, when the 11th key vector KV11 has a size corresponding to three physical pages, the storage controller 300 may determine to generate three commands and three addresses to be sent to three non-volatile memory devices respectively connected to three channels.

In an embodiment, the storage controller 300 may generate commands and addresses by referring to a channel table (e.g., the first channel table CT1 of FIG. 6A and the second channel table CT2 of FIG. 6B) and a mapping table (e.g., the mapping table MT of FIG. 7). For example, the storage controller 300 may generate commands and addresses to be sent to non-volatile memory devices respectively connected to three channels, based on a channel number corresponding to the first key matrix KM1 in the channel table. In an embodiment, the storage controller 300 may determine segments of the 11th key vector KV11 to be sent respectively to channels. For example, the storage controller 300 may divide the 11th key vector KV11 into at least one segment and may determine channels to which the divided segments of the 11th key vector KV11 are to be transmitted. In an embodiment, each segment of the 11th key vector KV11 may include information (or index) for restoration to the 11th key vector KV11 or information (or index) related to generation of the first key matrix KM1.

In an embodiment, operation S120 and operation S125 may be simultaneously performed. In an embodiment, operation S120 and operation S125 may be performed to partially overlap each other. In an embodiment, the order of operation S120 and operation S125 may be changed to the order of operation S125 and operation S120.

In operation S130, the storage controller 300 may send the commands, the addresses, and the 11th key vector KV11 to the non-volatile memory devices NVMs. In an embodiment, the storage controller 300 may send the commands, the addresses, and the 11th key vector KV11 to the non-volatile memory devices NVMs through a plurality of channels. For example, the storage controller 300 may send the commands, the addresses, and the 11th key vector KV11 to selected non-volatile memory devices respectively connected to the plurality of channels.

In operation S140, the non-volatile memory devices NVMs may write the data of the 11th key vector KV11 thus received. In an embodiment, the non-volatile memory devices NVMs may write the 11th key vector KV11 through a plurality of non-volatile memory devices. For example, the non-volatile memory devices NVMs may write the 11th key vector KV11, based on that each of selected non-volatile memory devices respectively connected to channels writes the 11th key vector KV11 in response to a command and an address. In detail, for example, referring to FIGS. 8A and 9, the non-volatile memory devices NVMs may perform the write operation of the 11th key vector KV11 by programming the segments of the 11th key vector KV11 in non-volatile memory devices respectively connected to the first channel 410a, the second channel 420a, and the third channel 430a.

In operation S150, the storage controller 300 may update the channel table. In an embodiment, the storage controller 300 may update the channel corresponding to the data label DL of the data written in operation S140, in the channel table. For example, the storage controller 300 may update a channel number corresponding to the first key matrix KM1 to which the 11th key vector KV11 belongs. In this case, the channel corresponding to the first key matrix KM1 in the channel table (e.g., the first channel table CT1 of FIG. 6A or the second channel table CT2 of FIG. 6B) may be a channel whose number follows the numbers of the channels receiving the commands in operation S130. In detail, for example, in a case of FIG. 8A where the data of the 11th key vector KV11 are written, the storage controller 300 may perform the update such that the channel corresponding to the first key matrix KM1 is changed to the fourth channel 440a.

In operation S160, the storage controller 300 may send a response, which indicates that the operation is completed, to the processor 200. In an embodiment, the storage controller 300 may simultaneously perform operation S150 and operation S160. In an embodiment, the storage controller 300 may perform operation S150 and operation S160 to partially overlap each other.

It should be understood that at least some of the operations of FIG. 9 may be simultaneously performed, may be performed to overlap each other, or the order of performing some of the operations of FIG. 9 is changed. For example, the storage controller 300 may perform operation S150 while the non-volatile memory devices NVMs perform operation S140. In FIG. 9, the description is given based on the write operation of the 11th key vector KV11, but this is provided as an example. It should be understood that the above description may be identically applied to key vectors or value vectors in addition to the 11th key vector KV11. Based on the operations of FIG. 9, the storage device 100 may distribute and store the data of the first key matrix KM1 in a plurality of channels. When the storage device 100 receives the read request for the first key matrix KM1 from the processor 200, the storage device 100 may quickly read the distributed and stored data by utilizing all the channels based on the operations of FIG. 9. The processor 200 may implement the artificial intelligence model (e.g., the transformer structure model for the LLM inference) easily and quickly, based on receiving data quickly from the storage device 100 of FIG. 9.

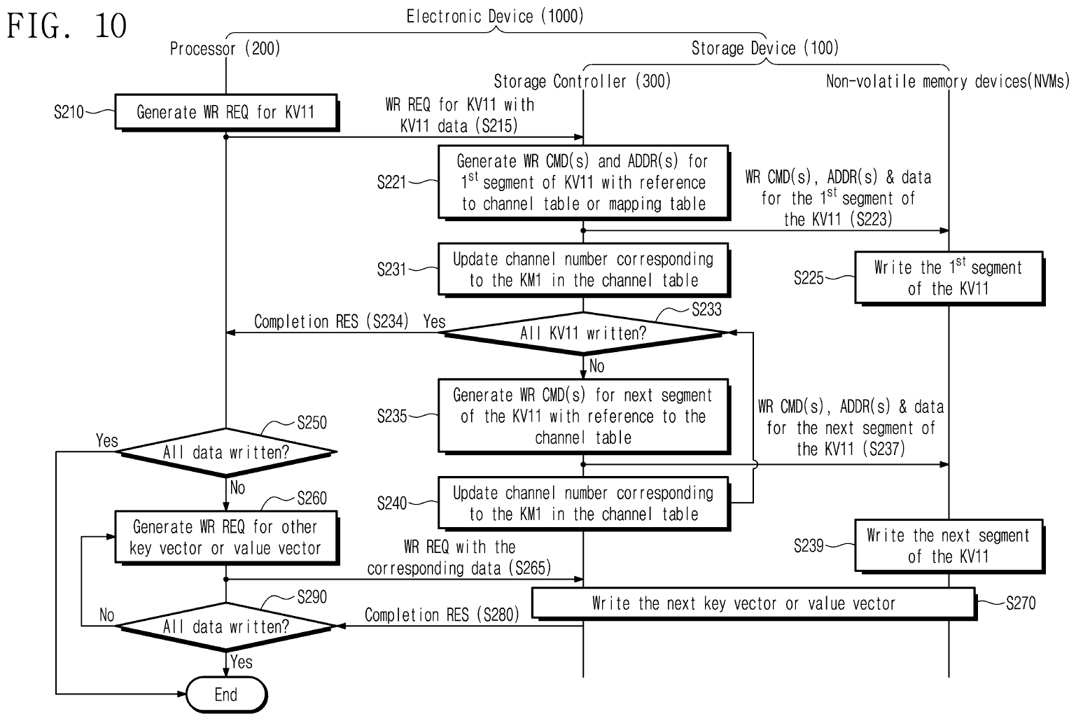

FIG. 10 is a flowchart illustrating a data write operation method of an electronic device of FIGS. 1 to 8C, according to one or more example embodiments of the disclosure. A data write method according to one or more example embodiments of the disclosure will be described with reference to FIGS. 1 to 8C and 10. In FIG. 10, the description will be given based on the 11th key vector KV11 included in the first key matrix KM1. However, this is provided as an example, and the scope of the disclosure is not limited thereto.

In operation S210, the processor 200 may generate the data write request REQ for the 11th key vector KV11. In an embodiment, the request REQ may include a data label associated with a data type of data to be written. For example, the processor 200 may generate the request REQ which is the same as or similar to the request REQ of FIG. 5, and the request REQ may include the data label DL associated with the first key matrix KM1. In operation S215, the processor 200 may send the generated request REQ and the data of the 11th key vector KV11 to be written in the storage device 100 to the storage controller 300. In an embodiment, the processor 200 may transfer the generated request REQ to the storage controller 110 through the communicator 220.

In operation S221, based on the request REQ, the storage controller 300 may generate a write command(s) and an address(es) for writing a first segment of the 11th key vector KV11. In an embodiment, the storage controller 300 may determine the entire number of commands and addresses to be generated, based on the data size DS of the request REQ and the size of a physical page. In an embodiment, the storage controller 300 may select non-volatile memory devices targeted for signal transmission/reception, by using a method the same as or similar to that described in operation S120 of FIG. 9.

The first segment of the 11th key vector KV11 may have a size corresponding to at least one or more physical pages. In an embodiment, portions corresponding to a size of one physical page of the first segment of the 11th key vector KV11 may be distributed to a plurality of channels to be sent to the non-volatile memory devices NVMs. In an embodiment, the size of the first segment may be identical to a product of the number of channels of the non-volatile memory devices NVMs and the size of the physical page. In an embodiment, the size of the first segment may be identical to a product of the number of some channels among the channels of the non-volatile memory devices NVMs and the size of the physical page.

In an embodiment, the storage controller 300 may generate commands and addresses to be sent to selected non-volatile memory devices respectively connected to a plurality of channels, by referring to a channel table (e.g., the first channel table CT1 of FIG. 6A and the second channel table CT2 of FIG. 6B) and a mapping table (e.g., the mapping table MT of FIG. 7). The storage controller 300 may perform operation S221 to be the same as or similar to operation S120 and operation S125 of FIG. 9.

In operation S223, the storage controller 300 may send the generated command(s), the generated address(es), and the data to the non-volatile memory devices NVMs. In an embodiment, the storage controller 300 may send the command(s), the address(es), and the data to the corresponding non-volatile memory device(s). In an embodiment, the non-volatile memory device(s) may be selected by the storage controller 300. (Alternatively, the non-volatile memory device(s) may constitute the entire way or a portion of a way). In an embodiment, the storage controller 300 may send the portions of the first segment of the 11th key vector KV11 to the corresponding non-volatile memory devices, respectively. The storage controller 300 may perform operation S223 by using a method which is the same as or similar to that described in operation S130 of FIG. 9.

In operation S225, the non-volatile memory devices NVMs may perform an operation of writing the first segment of the 11th key vector KV11. In an embodiment, the non-volatile memory devices NVMs may write the first segment of the 11th key vector KV11, based on that each of the selected non-volatile memory devices writes a portion of the 11th key vector KV11 in response to the command and the address. The non-volatile memory devices NVMs may perform operation S225 by using a method which is the same as or similar to that described in operation S140 of FIG. 9.

In operation S231, the storage controller 300 may update the channel corresponding to the first key matrix KM1 in a channel table (e.g., the first channel table CT1 of FIG. 6A or the second channel table CT2 of FIG. 6B). In an embodiment, the storage controller 300 may update the channel corresponding to the first key matrix KM1 in the channel table by using a method which is the same as or similar to the channel table update method of FIGS. 8A, 8B, and 8C. For example, the storage controller 300 may update the channel table such that a channel number of a channel following the last channel to which data or a portion(s) of the data is sent is changed to the channel number CN corresponding to the first key matrix KM1. In an embodiment, the storage controller 300 may perform operation S231 by using a method which is the same as or similar to that described in operation S150 of FIG. 9.

In operation S233, the storage controller 300 may determine whether all the 11th key vector KV11 is written in the non-volatile memory devices NVMs. When a portion of the 11th key vector KV11 is not written in the non-volatile memory devices NVMs, the storage controller 300 may proceed to operation S235. When all the 11th key vector KV11 is written in the non-volatile memory devices NVMs, the storage controller 300 may proceed to operation S234, in which the storage controller 300 may send a completion response to the processor 200.

In operation S235, the storage controller 300 may generate a write command(s) and an address(es) for writing a next segment of the 11th key vector KV11, by referring to the channel table. The storage controller 300 may generate a command(s) and an address(es) corresponding to a channel(s) by using a method which is the same as or similar to that described in operation S125 or operation S221 of FIG. 9. In an embodiment, the number of commands generated in operation S235 may be equal to or less than the number of channels; likewise, the number of addresses generated in operation S235 may be equal to or less than the number of channels.

In operation S237, the storage controller 300 may send the generated command(s), the generated address(es), and the data to the non-volatile memory devices NVMs. In an embodiment, the storage controller 300 may send portions of a next segment of the 11th key vector KV11 to non-volatile memory devices, respectively. (In an embodiment, the number of non-volatile memory devices receiving the portions of the next segment of the 11th key vector KV11 may be equal to the number of commands). The storage controller 300 may perform operation S237 by using a method which is the same as or similar to that described in operation S130 or operation S223 of FIG. 9.

In operation S239, the non-volatile memory devices NVMs may write a next segment(s) of the 11th key vector KV11. The non-volatile memory devices NVMs may perform operation S239 by using a method which is the same as or similar to that described in operation S140 or operation 225 of FIG. 9.

After operation S237, the storage controller 300 may proceed to operation S240. In operation S240, the storage controller 300 may update the channel corresponding to the first key matrix KM1 in the channel table (e.g., the first channel table CT1 of FIG. 6A or the second channel table CT2 of FIG. 6B). The storage controller 300 may perform operation S240 by using a method which is the same as or similar to that described in operation S150 or operation S231 of FIG. 9.

After operation S240, the storage controller 300 may return to operation S233. The storage controller 300 and the non-volatile memory devices NVMs may repeat operation S233, operation S235, operation S237, operation S239, and operation S240 similar to operations described above, such that all the 11th key vector KV11 is written in non-volatile memory devices respectively connected to the plurality of channels from among the non-volatile memory devices NVMs.

The processor 200 which receives the completion response in operation S234 may proceed to operation S250. In operation S250, the processor 200 may determine whether all the data targeted for the write operation are written. When all the data are written, the processor 200 may terminate the operation. When data to be written exist, the processor 200 may proceed to operation S260.

In operation S260, the processor 200 may generate the write request REQ for any other key vector or value vector. For example, the processor 200 may generate a request for writing a key vector included in the first key matrix KM1. For another example, the processor 200 may generate a request for writing a key vector included in a key matrix other than the first key matrix KM1 or a request for writing a value vector of a value matrix. In operation S260, the processor 200 may generate the write request for next data by using a method which is the same as or similar to that described in operation S210.

In operation S265, the processor 200 may send the request generated in operation S260 and data to be written to the storage controller 300. The processor 200 may operation S265 to be the same as or similar to operation S215.

In operation S270, the storage controller 300 and the non-volatile memory devices NVMs may write the data received in operation S265 in the non-volatile memory devices NVMs. The storage controller 300 and the non-volatile memory devices NVMs may write the data received in operation S265 in the non-volatile memory devices NVMs to be the same as or similar to operation S221 to operation S239. After the storage controller 300 completes operation S270, the storage controller 300 may proceed to operation S280, in which the storage controller 300 sends the completion response to the processor 200.

In operation S290, the processor 200 which receives the completion response may determine whether data to be written exist. When data to be written exist, the processor 200 may return to operation S260; when data to be written do not exist, the processor 200 may terminate the operation.

In FIG. 10, at least some of the operations may overlap each other, or at least some of the operations may be simultaneously performed. For example, the storage controller 300 may perform operation S231 while performing operation S223. For another example, while the storage controller 300 and the non-volatile memory devices NVMs perform operation S223 and operation S235, the storage controller 300 may perform operation S231 to operation S235. In FIG. 10, the description is given under the condition that the processor 200 sends the data of the 11th key vector KV11 to the storage controller 300 once, but the scope of the disclosure is not limited thereto. For example, it should be understood that an embodiment in which data to be written are sent to the storage controller 300 plural times also belongs to the scope of the disclosure.

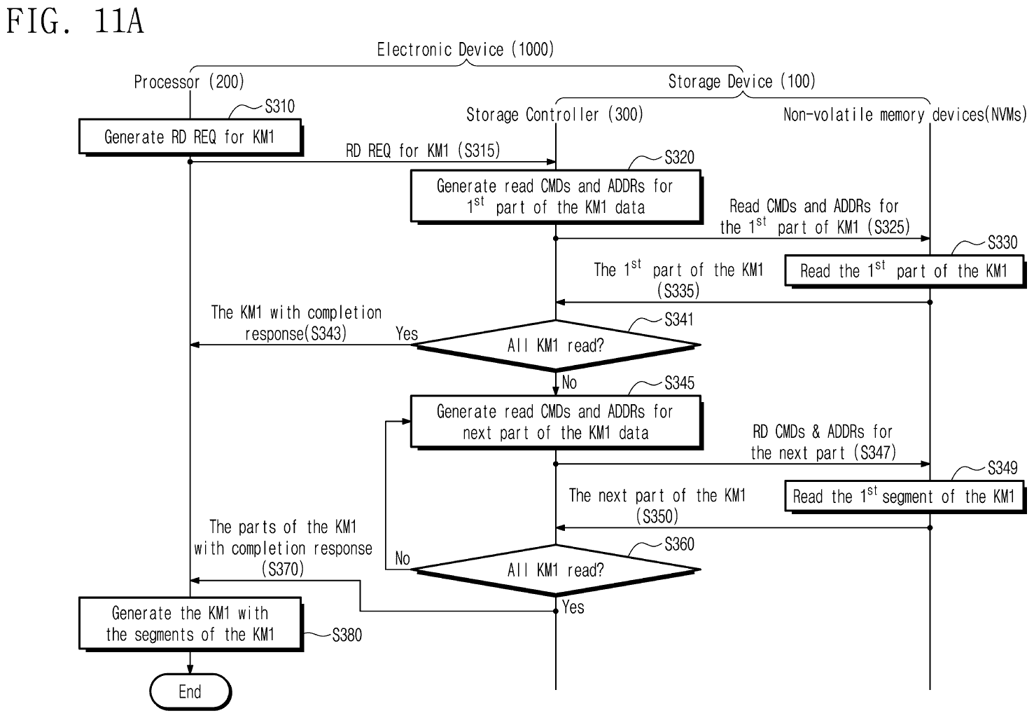

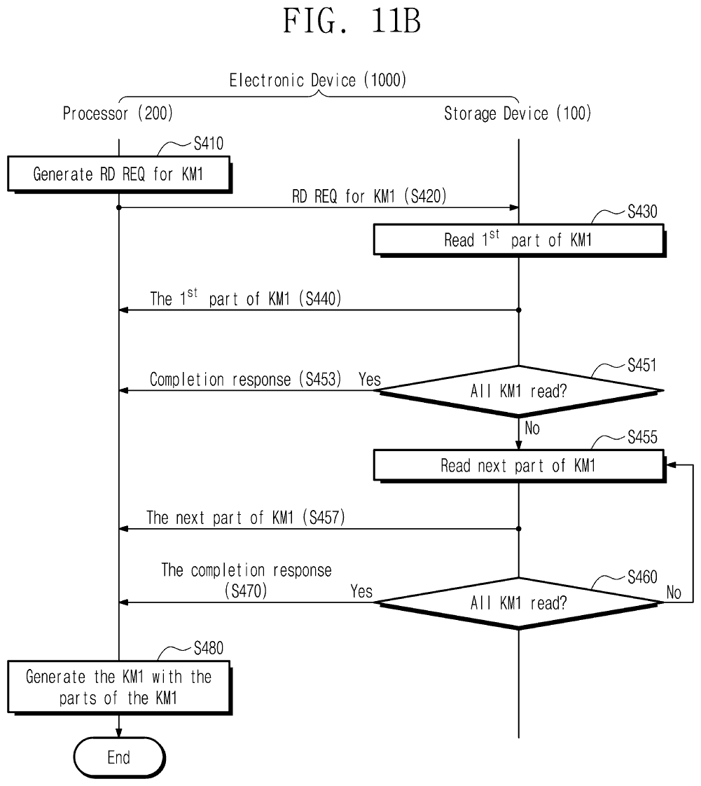

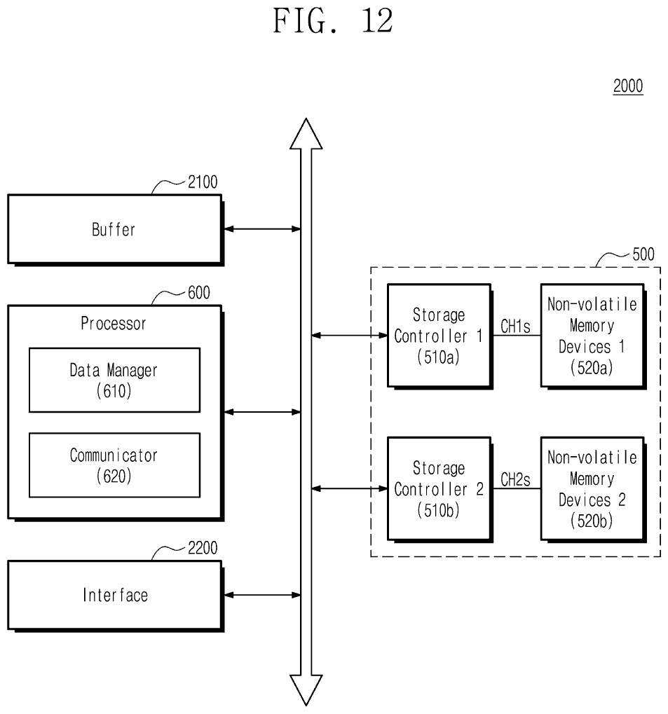

FIGS. 11A and 11B are flowcharts illustrating a data read method of an electronic device, according to one or more example embodiments of the disclosure. A data read operation method of an electronic device according to one or more example embodiments of the disclosure will be described with reference to FIGS. 1 to 8C, 11A, and 11B. FIGS. 11A and 11B will be described under the condition that an electronic device performs the read operation of the first key matrix KM1. However, this is provided as an example, and the disclosure is not limited thereto. It should be understood that the read operation may be identically or similarly performed on data of different types.

Referring to FIGS. 1 to 8C and 11A, in operation S310, the processor 200 may generate a read (RD) request REQ for the first key matrix KM1. In operation S310, the processor 200 may generate the read request to be similar to that described in operation S210. In an embodiment, the request REQ may include a data label associated with a data type of data to be read. For example, the processor 200 may generate a request which is the same as or similar to the request REQ of FIG. 5, and the request REQ may include the data label associated with the first key matrix KM1. In operation S315, the processor 200 may send the generated request REQ to the storage controller 300. In operation S315, the processor 200 may send the request REQ to the storage controller 300 by using a method which is the same as or similar to that described in operation S215 of FIG. 10.

In operation S320, the storage controller 300 may generate commands and addresses corresponding to the received request to read data of a first part of the first key matrix KM1. The storage controller 300 may select non-volatile memory devices targeted for the read operation. In an embodiment, the storage controller 300 may select non-volatile memory devices by using an operation which is the same as or similar to the NVM selection operation described in operation S120 of FIG. 9 or operation S221 of FIG. 10. In an embodiment, the selected non-volatile memory devices may constitute one way. For example, the storage controller 300 may select non-volatile memory devices targeted for the read operation by referring to the data label DL and the second channel table CT2.

In an embodiment, the size of the first part may be identical to a product of the number of channels of the non-volatile memory devices NVMs and the size of the physical page of the non-volatile memory device. In an embodiment, the storage controller 300 may generate commands and addresses by referring to the channel tables CT1 and CT2 of FIGS. 6A and 6B and the mapping table MT of FIG. 7. In an embodiment, the storage controller 300 may generate commands and addresses corresponding to all the channels of the non-volatile memory devices NVMs. For example, referring to FIGS. 2 and 11A together, the storage controller 110 may generate commands and addresses to be sent to the first channel CH1 and the second to n-th channels CH2 to CHn.

In operation S325, the storage controller 300 may send the commands and the addresses to the non-volatile memory devices NVMs. The storage controller 300 may perform operation S325 by using a method which is the same as or similar to that described in operation S130 of FIG. 9 or operation S223 of FIG. 10. In an embodiment, the storage controller 300 may send the commands and the addresses to the corresponding non-volatile memory devices. For example, the storage controller 300 may send the commands and the addresses to the corresponding selected non-volatile memory devices through a plurality of channels.

In operation S330, the non-volatile memory devices NVMs may read the first part of the first key matrix KM1. In an embodiment, the non-volatile memory devices NVMs may perform the read operation of the first part of the first key matrix KM1, based on the read operation of the selected non-volatile memory devices respectively connected to all the channels. After operation S330, the non-volatile memory devices NVMs may proceed to operation S335. In operation S335, the non-volatile memory devices NVMs may send the first part of the first key matrix KM1, which is read in operation S330, to the storage controller 300. After the storage controller 300 receives the first part of the first key matrix KM1, the storage controller 300 may proceed to operation S341.

In operation S341, the storage controller 300 may proceed to a next step, based on whether all the parts of the first key matrix KM1 are read. When all the parts of the first key matrix KM1 are read, the storage controller 300 may proceed to operation S343. In operation S343, the storage controller 300 may transfer the data of the first key matrix KM1 to the processor 200 together with a completion response. When all of the parts of the first key matrix KM1 are not read, the storage controller 300 may proceed to operation S345.

In operation S345, the storage controller 300 may generate commands and addresses for reading a next part of the first key matrix KM1. The storage controller 300 may perform operation S345 by using a method which is the same as or similar to that described in operation S320. In operation S347, the storage controller 300 may send the commands and the addresses generated in operation S345 to the non-volatile memory devices NVMs. The storage controller 300 may perform operation S347 by using a method which is the same as or similar to that described in operation S325.

In operation S349, the non-volatile memory devices NVMs may perform the read operation on the next part of the first key matrix KM1. The non-volatile memory devices NVMs may perform operation S349 by using a method which is the same as or similar to that described in operation S330. For example, the non-volatile memory devices NVMs may perform the read operation of the next part of the first key matrix KM1, based on the read operation of the selected non-volatile memory devices connected to one of all the channels.

After operation S349, the non-volatile memory devices NVMs may proceed to operation S350. In operation S350, the non-volatile memory devices NVMs may send the next part of the first key matrix KM1, which is read in operation S349, to the storage controller 300. The non-volatile memory devices NVMs may perform operation S350 by using a method which is the same as or similar to that described in operation S335.

The storage controller 300 which receives the next part of the first key matrix KM1 in operation S350 may proceed to operation S360. In operation S360, the storage controller 300 may determine whether the entire first key matrix KM1 is read. When any part of the first key matrix KM1 is not read, the storage controller 300 may return to operation S345 to read a next part of the first key matrix KM1. When the entire first key matrix KM1 is read, the storage controller 300 may proceed to operation S370.

In operation S370, the storage controller 300 may send the completion response to the processor 200 together with the read parts of the first key matrix KM1. The storage controller 300 may perform operation S370 by using a method which is the same as or similar to that described in operation S343.

In operation S380, the processor 200 may generate the first key matrix KM1. In an embodiment, the processor 200 may generate the first key matrix KM1, based on the parts of the first key matrix KM1 received from the storage controller 300. In an embodiment, the processor 200 may generate the first key matrix KM1 through the data manager 210 of FIG. 1. For example, the processor 200 may generate the first key matrix KM1 from the parts of the first key matrix KM1 received from the storage controller 300, through the data manager 210.

Based on the method described with reference to FIG. 11A, the non-volatile memory devices NVMs may read data by utilizing all the channels of the non-volatile memory devices NVMs. The processor 200 may implement the artificial intelligence (e.g., the transformer structure) more quickly or more easily, based on the data read scheme which utilizes all the channels of the non-volatile memory devices NVMs.

Referring to FIGS. 1 to 8C and 11B, in operation S410, the processor 200 may generate the read request for the first key matrix KM1. In an embodiment, the processor 200 may generate the read request REQ such as the request REQ of FIG. 5, and the read request may include the data label DL associated with the first key matrix KM1. The processor 200 may perform operation S410 by using a method which is the same as or similar to that described in operation S210 of FIG. 10 or operation S310 of FIG. 11A.

In operation S420, the processor 200 may send the generated read request to the storage device 100. For example, the processor 200 may send the generated read request to the storage controller 300 of FIG. 3. The processor 200 may perform operation S420 by using a method which is the same operation as or similar to that described in operation S215 of FIG. 10 or operation S315 of FIG. 11A.

In operation S430, the storage device 100 may perform the read operation on the first part of the first key matrix KM1. The storage device 100 may perform operation S430 by using a method which is the same as or similar to that described in operation S320, operation S325, and operation S330 of FIG. 11A. The storage device 100 may read the first part of the first key matrix KM1 from the non-volatile memory devices NVMs in operation S430.

In operation S440, the storage device 100 may transmit the first part of the first key matrix KM1 to the processor 200. In an embodiment, the processor 200 may temporarily store the received first part of the first key matrix KM1 in the buffer 1100 of FIG. 1. After operation S440, the storage device 100 may proceed to operation S451.

In operation S451, the storage device 100 may determine whether the entire first key matrix KM1 is read. After the first key matrix KM1 is completely read, the storage device 100 may proceed to operation S453, in which the storage device 100 sends the completion response to the processor 200. When the first key matrix KM1 is not completely read, the storage device 100 may proceed to operation S455.

In operation S455, the storage device 100 may perform the read operation on a next part of the first key matrix KM1. The storage device 100 may perform operation S455 by using a method which is the same as or similar to that described in operation S345, operation S347, and operation S349 of FIG. 11A. After operation S455, the storage device 100 may proceed to operation S457. In operation S457, the storage device 100 may transfer the next part of the first key matrix KM1 to the processor 200. The processor 200 may temporarily store the received next part of the first key matrix KM1 in the buffer 1100.

After operation S457, the storage device 100 may proceed to operation S460. In operation S460, the storage device 100 may determine whether the entire first key matrix KM1 is read. After the first key matrix KM1 is completely read, the storage device 100 may proceed to operation S470, in which the storage device 100 sends the completion response to the processor 200. When the first key matrix KM1 is not completely read, the storage device 100 may return to operation S455.

The processor 200 which receives the completion response may proceed to operation S480. In operation S480, the processor 200 may generate the first key matrix KM1, based on the received parts of the first key matrix KM1. The processor 200 may perform operation S480 by using a method which is the same as or similar to that described in operation S380 of FIG. 11A.

The operations of FIGS. 11A and 11B may be sequentially executed, or at least some thereof may be executed to overlap each other. FIGS. 11A and 11B are described based on the read operation of the first key matrix KM1, but it should be understood that this is provided as an example. It should be understood that the read operation on key matrices other than the first key matrix KM1 or the read operation value matrices may also be performed by using a method which is the same as or similar to the operation method of the electronic device described with reference to FIGS. 11A and 11B.

FIG. 12 is a block diagram illustrating an electronic device according to one or more example embodiments of the disclosure. Referring to FIG. 12, an electronic device 2000 may include a storage device 500, a processor 600, a buffer 2100, and an interface 2200. The electronic device 2000 of FIG. 12 may be the same as or similar to the electronic device 1000 of FIG. 1.

The buffer 2100 may temporarily store data of the electronic device 2000 or may store program codes or source codes which the processor 600 executes. The buffer 2100 may be the same as or similar to the buffer 1100 of FIG. 1. An operation of the buffer 2100 may be the same as or similar to the operation of the buffer 1100 of FIG. 1. The interface 2200 may perform communication with the outside of the electronic device 1000, may receive an external input, or may send an output to the outside. The interface 2200 may be the same as or similar to the interface 1200 of FIG. 1. An operation of the interface 2200 may be the same as or similar to the operation of the interface 1200 of FIG. 1.

The storage device 500 may store data of the electronic device 2000. In an embodiment, the storage device 500 may store data related to the operation of the processor 600. For example, the storage device 500 may store artificial intelligence model data of the processor 600 and may provide the artificial intelligence model data to the processor 600. An operation of the storage device 500 may be the same as or similar to the operation of the storage device 100 of FIG. 1. Referring to FIG. 12, the storage device 500 may include a first storage controller 510a, first non-volatile memory devices 520a, a second storage controller 510b, and second non-volatile memory devices 520b. The first non-volatile memory devices 520a may be connected to the first storage controller 510a through first channels CH1s, and the second non-volatile memory devices 520b may be connected to the second storage controller 510b through second channels CH2s.

The first storage controller 510a may be the same as or similar to the storage controller described with reference to FIGS. 1 to 3, 6A, 6B, and 7, and operations of the first storage controller 510a may be the same as or similar to the operations of the storage controller described with reference to FIGS. 1 to 3, 6A, 6B, and 7. The second storage controller 510b may be the same as or similar to the storage controller described with reference to FIGS. 1 to 3, 6A, 6B, and 7, and operations of the second storage controller 510b may be the same as or similar to the operations of the storage controller described with reference to FIGS. 1 to 3, 6A, 6B, and 7.

The first non-volatile memory devices 520a may be the same as or similar to the non-volatile memory devices described with reference to FIGS. 1 to 2, 8A, 8B, and 8C, and operations of the first non-volatile memory devices 520a may be the same as or similar to the operations of the non-volatile memory devices described with reference to FIGS. 1, 2, 8A, 8B, and 8C. The second non-volatile memory devices 520b may be the same as or similar to the non-volatile memory devices described with reference to FIGS. 1 to 2, 8A, 8B, and 8C, and operations of the second non-volatile memory devices 520b may be the same as or similar to the operations of the non-volatile memory devices described with reference to FIGS. 1, 2, 8A, 8B, and 8C. In an embodiment, the first storage controller 510a and the second storage controller 510b may operate independently of each other, and each of the first storage controller 510a and the second storage controller 510b may operate in response to the request of the processor 600.

The processor 600 may perform calculations related to the operation of the electronic device 2000. The processor 600 may be the same as or similar to the processor 200 of FIG. 1. Referring to FIG. 12, the processor 600 may include a data manager 610 and a communicator 620. The communicator 620 may perform communication between external units (e.g., the storage device 500) of the processor 600 and the processor 600 and may be the same as or similar to the communicator 220 of FIG. 1.

The data manager 610 may manage data which the processor 600 uses. The data manager 610 may manage data stored in the storage device 500 and the buffer 2100. The data manager 610 may be the same as or similar to the data manager 210 of FIG. 1, and an operation of the data manager 610 may be the same as or similar to the operation of the data manager 210 of FIG. 1. For example, the data manager 610 may allocate (e.g., distribute) data, a program code, or a source code of the artificial intelligence model, which the processor 600 implements, to the non-volatile memory devices 520a and 520b.

In an embodiment, the data manager 610 may designate data to be stored in the first non-volatile memory devices 520a and the second non-volatile memory devices 520b and may manage a storage location. Referring to FIGS. 4 to 7 together, for example, the data manager 610 may allocate the first key vectors KV11 and KV12 to KV1N included in the first key matrix KM1 to the first non-volatile memory devices 520a and the second non-volatile memory devices 520b. For another example, the data manager 610 may allocate segments of the first key vectors KV11 and KV12 to KV1N to the first non-volatile memory devices 520a and the second non-volatile memory devices 520b such that the first key vectors KV11 and KV12 to KV1N included in the first key matrix KM1 are distributed to the first non-volatile memory devices 520a and the second non-volatile memory devices 520b. In detail, for example, the data manager 610 may store first segments of the 11th key vector KV11 in the first non-volatile memory devices 520a and may store the second segments of the 11th key vector KV11 in the second non-volatile memory devices 520b.

In an embodiment, the data manager 610 may manage locations of the distributed and stored data. Referring to FIGS. 4 to 7 together, for example, when the first key vectors KV11 and KV12 to KV1N included in the first key matrix KM1 are distributed and stored to the non-volatile memory devices 520a and 520b, the data manager 610 may manage information (e.g., storage locations) of key vectors which the non-volatile memory devices 520a and 520b store, respectively. For another example, the first key vectors KV11 and KV12 to KV1N are distributed and stored to the non-volatile memory devices 520a and 520b, the data manager 610 may manage locations where the first segments and the second segments of each of the first key vectors KV11 and KV12 to KV1N are stored. In an embodiment, the data manager 610 may store the storage location information of the data distributed and stored in the non-volatile memory devices 520a and 520b in the buffer 2100 or the storage device 500.

For convenience of description, the first key matrix KM1 is described as an example. However, this is provided as an example, and it should be understood that the above description may be identically applied to key matrices other than the first key matrix KM1, key vectors, value matrices, or value vectors. The electronic device 2000 of FIG. 12 may allocate data of a specific type to channels, the number of which is more than that of the electronic device 1000 of FIG. 1, and may store the data of the specific type in non-volatile memory devices connected to the channels. The processor 600 of the electronic device 2000 of FIG. 12 may read data from a wider region to implement the artificial intelligence model more easily and more quickly.

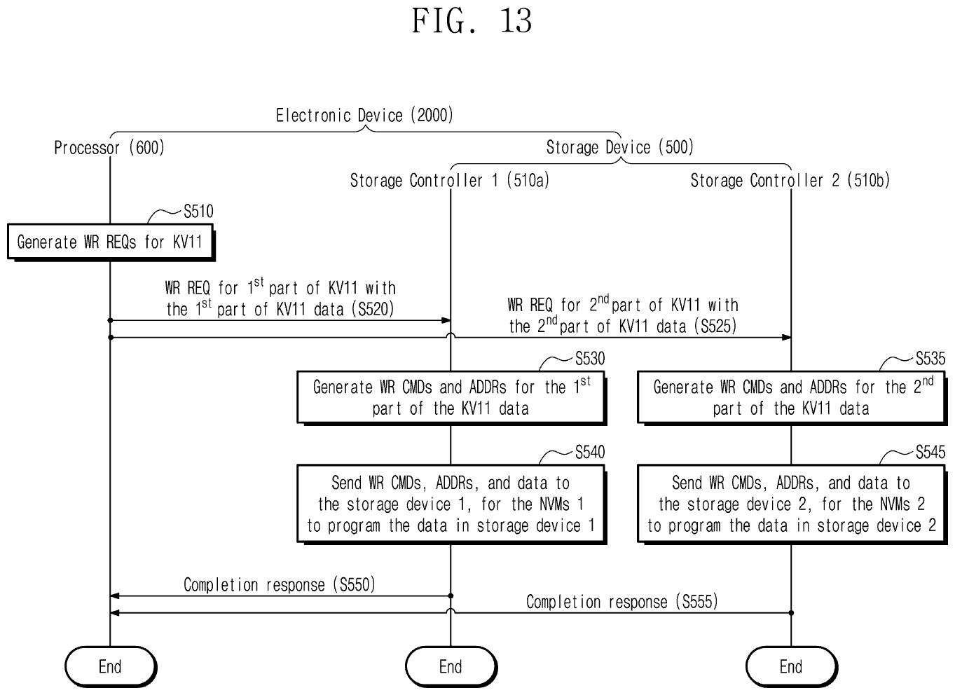

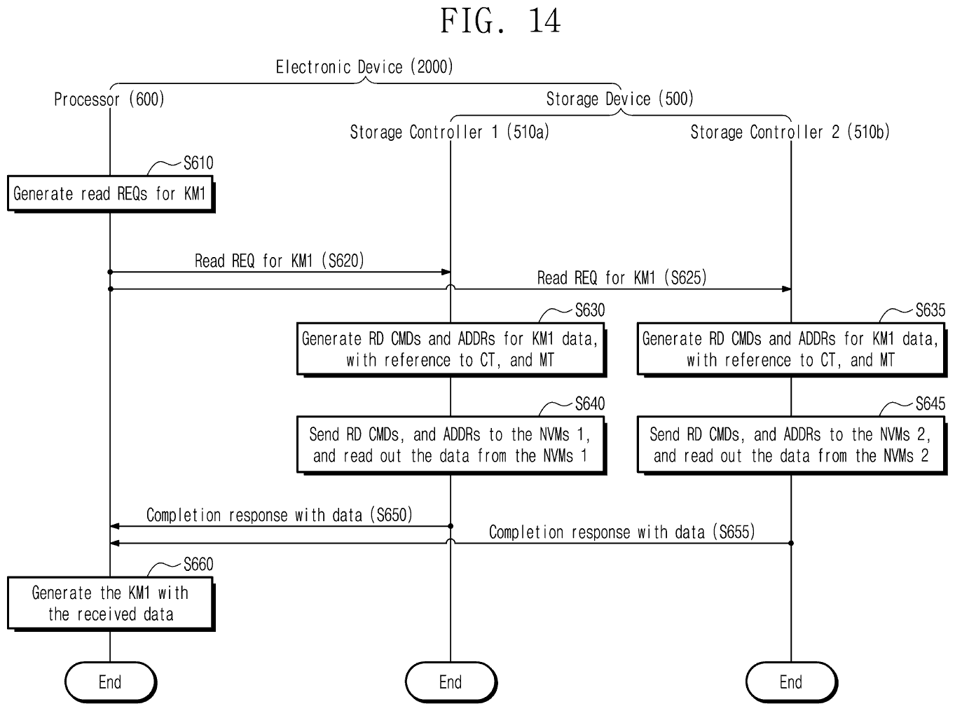

FIG. 13 is a flowchart illustrating a data write method of an electronic device of FIG. 12, according to one or more example embodiments of the disclosure. The data write method of the electronic device 2000 of FIG. 12, according to one or more example embodiments of the disclosure, will be described with reference to FIGS. 3 to 8C, 12, and 13. In FIG. 13, the description will be given under the condition that the 11th key vector KV11 is distributed and stored in the non-volatile memory devices 520a and 520b, but the scope of the disclosure is not limited thereto. It should be understood that an embodiment in which the electronic device 2000 of FIG. 12 distributes and stores key vectors included in the first key matrix KM1 in the non-volatile memory devices 520a and 520b by using a method being the same as or similar to the method described with reference to FIG. 10.

In operation S510, the processor 600 may generate write request REQs for the 11th key vector KV11. The processor 600 may generate the write request by using a method which is the same as or similar to that described in operation S210 of FIG. 10. In an embodiment, each of the write requests may be the same as or similar to the request REQ of FIG. 5. For example, the processor 600 may generate a request to be sent to the first storage controller 510a or a request to be sent to the second storage controller 510b.

In operation S520, the processor 600 may send the write request for the first part of the 11th key vector KV11 and data of the first part of the 11th key vector KV11 to the first storage controller 510a. In operation S525, the processor 600 may send the write request for the second part of the 11th key vector KV11 and data of the second part of the 11th key vector KV11 to the second storage controller 510b. The processor 600 may perform operation S520 or operation S525 by using a method which is the same as or similar to that described in operation S215 or operation S265 of the processor 200 of FIG. 10. In an embodiment, the processor 600 may simultaneously perform operation S520 and operation S525 or may perform operation S520 and operation S525 to partially overlap each other.

In operation S530, the first storage controller 510a may generate commands and addresses of the write operation on the first part of the 11th key vector KV11. In an embodiment, the first storage controller 510a may generate commands and addresses by referring to a channel table (e.g., the first channel table CT1 of FIG. 6A and the second channel table CT2 of FIG. 6B) and a mapping table (e.g., the mapping table MT of FIG. 7). The first storage controller 510a may perform operation S530 by using a method which is the same as or similar to that described in operation S120 and operation S125 of FIG. 9, operation S221 of FIG. 10, or operation S235 of FIG. 10.

In operation S535, the second storage controller 510b may generate commands and addresses of the write operation on the second part of the 11th key vector KV11. In an embodiment, the second storage controller 510b may generate commands and addresses by referring to a channel table (e.g., the first channel table CT1 of FIG. 6A and the second channel table CT2 of FIG. 6B) and a mapping table (e.g., the mapping table MT of FIG. 7). The second storage controller 510b may perform operation S535 by using a method which is the same as or similar to that described in operation S120 and operation S125 of FIG. 9, operation S221 of FIG. 10, or operation S235 of FIG. 10.

In operation S540, the first storage controller 510a may send the generated write commands, the generated addresses, and the first part of the 11th key vector KV11 to the first non-volatile memory devices 520a. Through operation S540, the first storage controller 510a may allocate the first part of the 11th key vector KV11 to a plurality of channels of the first non-volatile memory devices 520a and may control non-volatile memory devices of each channel such that the non-volatile memory devices of each channel program the first part of the 11th key vector KV11.

In an embodiment, in operation S540 or after operation S540, the first storage controller 510a may update the channel corresponding to the first key matrix KM1 in the channel table. The first storage controller 510a may perform operation S540 to be the same as or similar to operation S130 of FIG. 9.

In FIG. 13, the description is given as the first part of the 11th key vector KV11 is written in the first non-volatile memory devices 520a in operation S530 and operation S540, but the scope of the disclosure is not limited thereto. In an embodiment, the first storage controller 510a may perform operation S530 and operation S540 by using a method which is the same as or similar to that described in operation S221, operation S223, operation S231, operation S233, operation S235, operation S237, or operation S240 of FIG. 10.

In operation S545, the second storage controller 510b may send the generated write commands, the generated addresses, and the second part of the 11th key vector KV11 to the second non-volatile memory devices 520b. Through operation S545, the second storage controller 510b may allocate the second part of the 11th key vector KV11 to a plurality of channels of the second non-volatile memory devices 520b and may control non-volatile memory devices of each channel such that the non-volatile memory devices of each channel program the second part of the 11th key vector KV11. In an embodiment, in operation S545 or after operation S545, the second storage controller 510b may update the channel corresponding to the first key matrix KM1 in the channel table. The second storage controller 510b may perform operation S540 to be the same as or similar to operation S130 of FIG. 9.

In FIG. 13, the description is given as the second part of the 11th key vector KV11 is written in the second non-volatile memory devices 520b in operation S535 and operation S545, but the scope of the disclosure is not limited thereto. In an embodiment, the second storage controller 510b may perform operation S535 and operation S545 by using a method which is the same as or similar to that described in operation S221, operation S223, operation S231, operation S233, operation S235, operation S237, or operation S240 of FIG. 10. In an embodiment, at least some of operation S530 and operation S540 of the first storage controller 510a and operation S535 and operation S545 of the second storage controller 510b may be performed to overlap each other.

In operation S550, the first storage controller 510a may send a completion response to the processor 600. In operation S555, the second storage controller 510b may send a completion response to the processor 600. In an embodiment, operation S550 and operation S555 may be performed to at least partially overlap each other.

Based on the operation of the electronic device 2000 described with reference to FIG. 13, the storage device 500 may distribute and store data in a plurality of channels of the plurality of non-volatile memory devices 520a and 520b or all the channels of the plurality of non-volatile memory devices 520a and 520b. Because the data are distributed and stored through the data write operation described with reference to FIG. 13, the distributed and stored data may be read at higher speed. For example, the processor 600 may implement the artificial intelligence model more quickly and more easily, based on the data write operation of the electronic device 2000 of FIG. 13. In FIG. 13, the operation of the electronic device 2000 is described based on the 11th key vector KV11, but the scope of the disclosure is not limited thereto. For example, it should be understood that the above description may be identically or similarly applied to the remaining key vectors or value vectors.

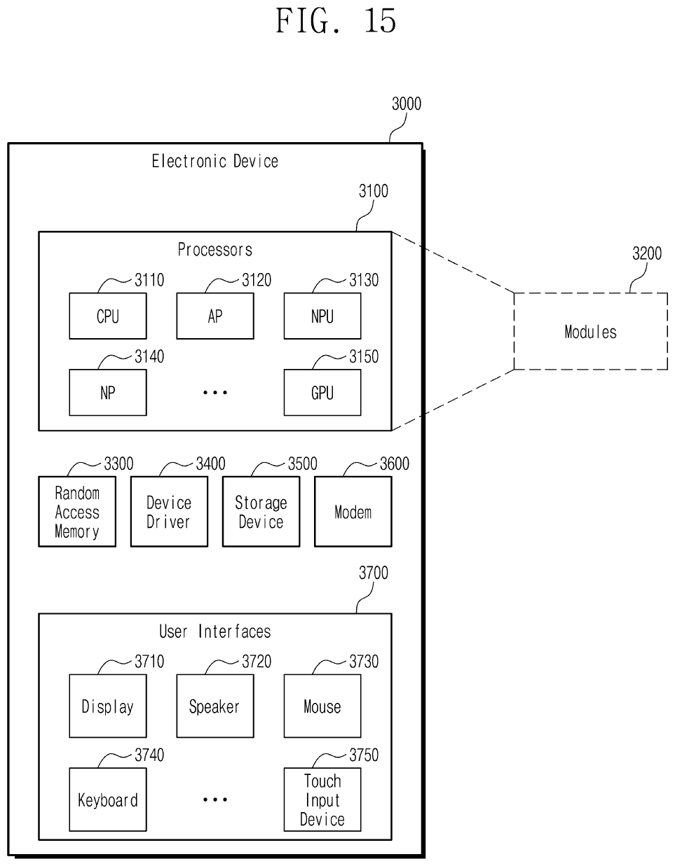

FIG. 14 is a flowchart illustrating a data read operation method of an electronic device of FIG. 12, according to one or more example embodiments of the disclosure. The data read method of the electronic device 2000 of FIG. 12, according to one or more example embodiments of the disclosure, will be described with reference to FIGS. 3 to 8C, 12, and 14. FIG. 14 will be described based on the first key matrix KM1, but it should be understood that the description to be described with reference to FIG. 14 may be identically applied to the remaining key matrices or a value matrix.

In operation S610, the processor 600 may generate the read requests for the first key matrix KM1. In an embodiment, the processor 600 may generate a plurality of read requests which are the same as or similar to the request REQ of FIG. 5. The processor 600 may perform operation S610 by using a method which is the same operation as or similar to that described in operation S310 of FIG. 11A, operation S410 of FIG. 11B, or operation S510 of FIG. 13.

In operation S620, the processor 600 may transfer the read request for the first key matrix KM1 to the first storage controller 510a. In operation S625, the processor 600 may transfer the read request for the first key matrix KM1 to the second storage controller 510b. The processor 600 may perform operation S620 or operation S625 to be the same as or similar to operation S315 of FIG. 11A or operation S420 of FIG. 11B. In an embodiment, operation S620 and operation S625 may be performed to at least partially overlap each other.

In operation S630, the first storage controller 510a may generate read commands and addresses for the first key matrix KM1 by referring to a channel table (e.g., the first channel table CT1 of FIG. 6A or the second channel table CT2 of FIG. 6B) and the mapping table MT. The first storage controller 510a may perform operation S630 to be the same as or similar to operation S320 or operation S345 of FIG. 11A. In operation S635, the second storage controller 510b may generate read commands and addresses for the first key matrix KM1 by referring to a channel table (e.g., the first channel table CT1 of FIG. 6A or the second channel table CT2 of FIG. 6B) and the mapping table MT. The second storage controller 510b may perform operation S635 to be the same as or similar to operation S320 or operation S345 of FIG. 11A. Operation S630 and operation S640 may be performed to at least partially overlap each other.

In operation S640, the first storage controller 510a may send the commands and the addresses to the first non-volatile memory devices 520a to read a part of the first key matrix KM1 from the first non-volatile memory devices 520a. In an embodiment, the first storage controller 510a may send the commands and the addresses to the first non-volatile memory devices 520a to be the same as or similar to that described in operation S325 or operation S347 of FIG. 11A. In an embodiment, the first storage controller 510a may receive the part of the first key matrix KM1 from the first non-volatile memory devices 520a to be the same as or similar to that described in operation S335 or operation S350 of FIG. 11A.

In operation S645, the second storage controller 510b may send the commands and the addresses to the second non-volatile memory devices 520b to read a part of the first key matrix KM1 from the second non-volatile memory devices 520b. In an embodiment, the second storage controller 510b may send the commands and the addresses to the second non-volatile memory devices 520b to be the same as or similar to that described in operation S325 or operation S347 of FIG. 11A. In an embodiment, the second storage controller 510b may receive the part of the first key matrix KM1 from the second non-volatile memory devices 520b to be the same as or similar to that described in operation S335 or operation S350 of FIG. 11A.

In operation S650, the first storage controller 510a may send the read data to the processor 600 together with a completion response. In an embodiment, through operation S650, the first storage controller 510a may send the part of the first key matrix KM1 to the processor 600. In operation S655, the second storage controller 510b may send the read data to the processor 600 together with a completion response. In an embodiment, through operation S655, the second storage controller 510b may send the part of the first key matrix KM1 to the processor 600.

In FIG. 14, the description is given as the storage controllers 510a and 510b generate commands and addresses once to read a part of data of the first key matrix KM1, but the scope of the disclosure is not limited thereto. In an embodiment, the first storage controller 510a may perform operation S630, operation S640, and operation S650 to be the same as or similar to the operations of the storage controller 300 in operation S320 to operation S370 of FIG. 11A or the operations of the storage controller 300 in operation S420 to operation S470 of FIG. 11B. In an embodiment, the second storage controller 510b may perform operation S635, operation S645, and operation S655 to be the same as or similar to the operations of the storage controller 300 in operation S320 to operation S370 of FIG. 11A or the operations of the storage controller 300 in operation S420 to operation S470 of FIG. 11B.

In operation S660, the processor 600 may generate the first key matrix KM1, based on the received data. For example, the processor 600 may generate the first key matrix KM1 by adding the first part of the first key matrix KM1 received from the first storage controller 510a and the second part of the first key matrix KM1 received from the second storage controller 510b. In an embodiment, the processor 600 may perform operation S660 to be the same as or similar to operation S380 of FIG. 11A or operation S480 of FIG. 11B.

The electronic device 2000 may efficiently read data distributed to a plurality of channels of a plurality of memory devices, based on the method described with reference to FIG. 14. The electronic device 2000 may perform various operations including an operation of implementing the artificial intelligence model quickly and easily, based on the efficiently read data (e.g., the artificial intelligence model data).

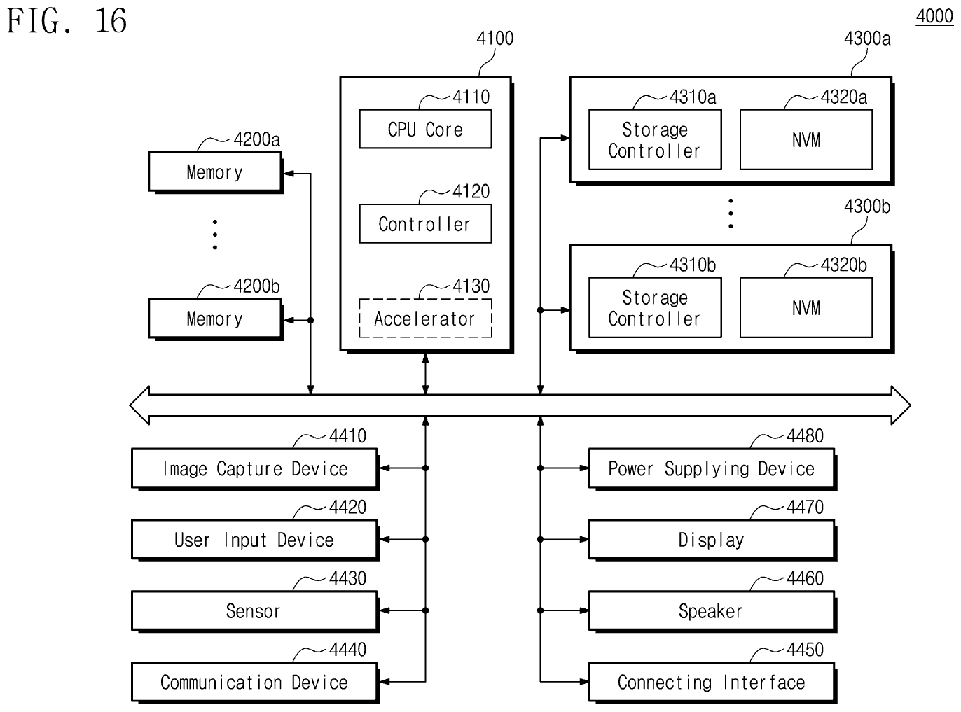

FIG. 15 is a block diagram illustrating an electronic device according to one or more example embodiments of the disclosure. Referring to FIG. 15, an electronic device 3000 may include processors 3100, a random access memory 3300, a device driver 3400, a storage device 3500, a modem 3600, and user interfaces 3700.

The processors 3100 may include, for example, a central processing unit (CPU) 3110 or at least one general-purpose processor such as an application processor (AP) 3120. The processors 3100 may include at least one special-purpose processor such as a neural processor 3130, a neuromorphic processor 3140, or a graphics processing unit 3150. The processors 3100 may include two or more homogeneous processors.

In an embodiment, the processors 3100 may be the processor described with reference to FIGS. 1 to 14 or may be included in the processor. In FIG. 15, it should be understood that an embodiment in which the processors 3100 do not include some processors also belongs to the scope of the disclosure. For example, the processors 3100 may include the central processing unit 3110 and the graphics processing unit 3150.

At least one of the processors 3100 may execute modules 3200. In an embodiment, at least some of the modules 3200 may include a module trained based on the machine learning or deep learning, and at least others of the modules 3200 may include a module operating based on a given algorithm. For example, the modules 3200 may include a language model or an artificial intelligence model for large language model inference.

At least one of the processors 3100 may be used to train the modules 3200 (e.g., some associated with the learning from among the modules 3200) or may be used to execute the trained modules 3200. At least one of the processors 3100 may train or execute the modules 3200 based on a variety of data or information. For example, the modules 3200 may be implemented in the form of instructions (or codes) which are executed by at least one of the processors 3100. In this case, the at least one processor may load the instructions (or codes) of the modules 3200 to the random access memory 3300. Also, the at least one processor may load data (e.g., model data) of the modules 3200 on the random access memory 3300 or the storage device 3500.

As another example, the at least one among the processors 3100 (or at least another of the processors 3100) may be manufactured to implement the modules 3200. For example, the at least one processor may be a dedicated processor that is implemented in hardware based on the modules 3200 generated by the learning of the modules 3200.

As another example, the at least one among the processors 3100 (or at least another of the processors 3100) may be manufactured to implement various machine learning or deep learning modules. The at least one processor may implement the modules 3200 by receiving information (e.g., instructions or codes) corresponding to the modules 3200.

The random access memory 3300 may be used as a working memory of the processors 3100 and may be used as a main memory or a system memory of the electronic device 3000. The random access memory 3300 may include a volatile memory such as a dynamic random access memory or a static random access memory, or a nonvolatile memory such as a phase-change random access memory, a ferroelectric random access memory, a magnetic random access memory, or a resistive random access memory. In an embodiment, the random access memory 3300 may be the buffer described with reference to FIGS. 1 to 14 or may be included in the buffer.

The device driver 3400 may control the following peripheral devices based on a request of the processors 3100: the storage device 3500, the modem 3600, and the user interfaces 3700. The storage device 3500 may include a stationary storage device such as a hard disk drive or a solid state drive, or a removable storage device such as an external hard disk drive, an external solid state drive, or a removable memory card. In an embodiment, the storage device 3500 may include the storage device described with reference to FIGS. 1 to 14 or may include the storage device.

The modem 3600 may provide remote communication with the external device. The modem 3600 may perform wired or wireless communication with the external device. The modem 3600 may communicate with the external device based on at least one of various communication schemes such as Ethernet, wireless-fidelity (Wi-Fi), long term evolution (LTE), and 5th generation (5G) mobile communication.

The user interfaces 3700 may receive information from the user and may provide information to the user. The user interfaces 3700 may include at least one user output interface such as a display 3710 or a speaker 3720, and at least one user input interface such as a mouse 3730, a keyboard 3740, or a touch input device 3750.

The instructions (or codes) of the modules 3200 may be received through the modem 3600 and may be stored in the storage device 3500. The instructions (or codes) of the modules 3200 may be stored in a removable storage device, and the removable storage device may be connected to the electronic device 3000. The instructions (or codes) of the modules 3200 may be loaded to the random access memory 3300 from the storage device 3500 to be executed.

FIG. 16 is a diagram of a system 4000 to which a storage device is applied, according to an embodiment. The system 4000 of FIG. 16 may basically be a mobile system, such as a portable communication terminal (e.g., a mobile phone), a smartphone, a tablet personal computer (PC), a wearable device, a healthcare device, or an Internet of things (IOT) device. However, the system 4000 of FIG. 16 is not necessarily limited to the mobile system and may be a PC, a laptop computer, a server, a media player, or an automotive device (e.g., a navigation device).

In an embodiment, the system 4000 may be a system providing AI (artificial intelligence) leaning or inference. For example, the system 4000 may implement and provide large language model inference.

Referring to FIG. 16, the system 4000 may include a main processor 4100, memories (e.g., 4200a and 4200b), and storage devices (e.g., 4300a and 4300b). In addition, the system 4000 may include at least one of an image capturing device 4410, a user input device 4420, a sensor 4430, a communication device 4440, a connecting interface 4450, a speaker 4460, a display 4470, and a power supplying device 4480.

The main processor 4100 may control all operations of the system 4000, more specifically, operations of other components included in the system 4000. The main processor 4100 may be implemented as a general-purpose processor, a dedicated processor, or an application processor.

The main processor 4100 may include at least one CPU core 4110 and further include a controller 4120 configured to control the memories 4200a and 4200b and/or the storage devices 4300a and 4300b. In some embodiments, the main processor 4100 may further include an accelerator 4130, which is a dedicated circuit for a high-speed data operation, such as an artificial intelligence (AI) data operation. The accelerator 4130 may include a graphics processing unit (GPU), a neural processing unit (NPU) and/or a data processing unit (DPU) and be implemented as a chip that is physically separate from the other components of the main processor 4100. The main processor 4100 may include the processor 200 or 600 of FIGS. 1 to 17.

The memories 4200a and 4200b may be used as main memory devices of the system 4000. Although each of the memories 4200a and 4200b may include a volatile memory, such as static random access memory (SRAM) and/or dynamic RAM (DRAM), each of the memories 4200a and 4200b may include non-volatile memory, such as a flash memory, phase-change RAM (PRAM) and/or resistive RAM (RRAM). The memories 4200a and 4200b may be implemented in the same package as the main processor 4100.

The storage devices 4300a and 4300b may serve as non-volatile storage devices configured to store data regardless of whether power is supplied thereto, and have larger storage capacity than the memories 4200a and 4200b. The storage devices 4300a and 4300b may respectively include storage controllers (STRG CTRL) 4340a and 4340b and NVMs (Non-Volatile Memories) 4320a and 4320b configured to store data via the control of the storage controllers 4340a and 4340b. Although the NVMs 4320a and 4320b may include flash memories having a two-dimensional (2D) structure or a three-dimensional (3D) V-NAND structure, the NVMs 4320a and 4320b may include other types of NVMs, such as PRAM and/or RRAM.

The storage devices 4300a and 4300b may be physically separated from the main processor 4100 and included in the system 4000 or implemented in the same package as the main processor 4100. In addition, the storage devices 4300a and 4300b may have types of solid-state devices (SSDs) or memory cards and be removably combined with other components of the system 4000 through an interface, such as the connecting interface 4450 that will be described below. The storage devices 4300a and 4300b may be devices to which a standard protocol, such as a universal flash storage (UFS), an embedded multi-media card (eMMC), or a non-volatile memory express (NVMe), is applied, without being limited thereto.

Each of the storage devices 4300a and 4300b may be the storage device of FIGS. 1 to 17 or may include the storage device. In FIG. 16, each of the storage devices 4300a and 4300b is illustrated as including one non-volatile memory device. However, the scope of the disclosure is not limited thereto, and it should be understood that each of the storage devices 4300a and 4300b includes a plurality of non-volatile memory devices as illustrated in FIG. 2. Each of the storage controller 4310a and 4310b may be the storage controller of FIGS. 1 to 17 or may include the storage controller.

The image capturing device 4410 may capture still images or moving images. The image capturing device 4410 may include a camera, a camcorder, and/or a webcam.

The user input device 4420 may receive various types of data input by a user of the system 4000 and include a touch pad, a keypad, a keyboard, a mouse, and/or a microphone.

The sensor 4430 may detect various types of physical quantities, which may be obtained from the outside of the system 4000, and convert the detected physical quantities into electric signals. The sensor 4430 may include a temperature sensor, a pressure sensor, an illuminance sensor, a position sensor, an acceleration sensor, a biosensor, and/or a gyroscope sensor.

The communication device 4440 may transmit and receive signals between other devices outside the system 4000 according to various communication protocols. The communication device 4440 may include an antenna, a transceiver, and/or a modem.

The connecting interface 4450 may provide connection between the system 4000 and an external device, which is connected to the system 4000 and capable of transmitting and receiving data to and from the system 4000. The connecting interface 4450 may be implemented by using various interface schemes, such as advanced technology attachment (ATA), serial ATA (SATA), external SATA (e-SATA), small computer small interface (SCSI), serial attached SCSI (SAS), peripheral component interconnection (PCI), PCI express (PCIe), NVMe, IEEE 1394, a universal serial bus (USB) interface, a secure digital (SD) card interface, a multi-media card (MMC) interface, an eMMC interface, a UFS interface, an embedded UFS (eUFS) interface, and a compact flash (CF) card interface.

The speaker 4460 and the display 4470 may serve as output devices configured to respectively output auditory information and visual information to the user of the system 4000.

The power supplying device 4480 may appropriately convert power supplied from a battery (not shown) embedded in the system 4000 and/or an external power source, and supply the converted power to each of components of the system 4000.

According to one or more example embodiments of the disclosure, a memory device which allows an artificial intelligence accelerator to perform an inference operation at higher speed by storing a high-capacity artificial intelligence model and storing data to be suitable for a model inference operation, an operation method thereof, and an electronic device including the same are provided.

At least one of the components, elements, modules or units (collectively “components” in this paragraph) represented by a block in the drawings, may be embodied as various numbers of hardware, software and/or firmware structures that execute respective functions described above, according to an example embodiment. For example, at least one of these components may use a direct circuit structure, such as a memory, a processor, a logic circuit, a look-up table, etc. that may execute the respective functions through controls of one or more microprocessors or other control apparatuses. Also, at least one of these components may be specifically embodied by a module, a program, or a part of code, which contains one or more executable instructions for performing specified logic functions, and executed by one or more microprocessors or other control apparatuses. Further, at least one of these components may include or may be implemented by a processor such as a central processing unit (CPU) that performs the respective functions, a microprocessor, or the like. Two or more of these components may be combined into one single component which performs all operations or functions of the combined two or more components. Also, at least part of functions of at least one of these components may be performed by another of these components. Further, although a bus is not illustrated in the above block diagrams, communication between the components may be performed through the bus. Functional aspects of the above example embodiments may be implemented in algorithms that execute on one or more processors. Furthermore, the components represented by a block or processing steps may employ any number of related art techniques for electronics configuration, signal processing and/or control, data processing and the like.

While the disclosure has been described with reference to embodiments thereof, it will be apparent to those of ordinary skill in the art that various changes and modifications may be made thereto without departing from the spirit and scope of the disclosure as set forth in the following claims.

What is claimed is:

1. An operation method of a storage controller which is connected to a plurality of non-volatile memory devices configured to store inference data of a large language model (LLM) through a plurality of channels, the method comprising:
receiving a first request for writing a first key vector corresponding to a first data type;
storing the first key vector in at least one first non-volatile memory device connected to one or more first channels among the plurality of channels, by referring to the first data type and a channel table; and
updating the channel table such that a channel corresponding to the first data type is changed to a second channel among the plurality of channels.

2. The method of claim 1, further comprising:
receiving a second request for writing a second key vector corresponding to the first data type;
storing the second key vector in at least one second non-volatile memory device connected to one or more third channels among the plurality of channels, by referring to the first data type and the channel table; and
updating the channel table such that the channel corresponding to the first data type is changed to a fourth channel.

3. The method of claim 1, wherein the at least one first non-volatile memory device constitutes a first way.

4. The method of claim 2, wherein each of the at least one first non-volatile memory device receives at least one segment of the first key vector, and
wherein a size of the at least one segment of the first key vector is identical.

5. The method of claim 4, wherein the size of the at least one segment is identical to a size of one physical page of each of the plurality of non-volatile memory devices.

6. The method of claim 5, wherein at least one of the one or more third channels is included in the one or more first channels.

7. The method of claim 2, wherein the at least one first non-volatile memory device constitutes a first way, and
wherein the at least one second non-volatile memory device constitutes the first way.

8. The method of claim 7, wherein the channel table includes information of a next channel in which data are to be written, for each data type, and further includes a second data type and a channel corresponding to the second data type.

9. The method of claim 8, wherein the first data type is a first key matrix,
wherein the second data type is a first value matrix, and
wherein the first key matrix and the first value matrix are included in a first layer of the large language model.

10. The method of claim 8, wherein the channel table further includes information of a way constituted by at least one non-volatile memory device in which data are to be written, for each of the first data type and the second data type.

11. A storage device configured to store inference data of a large language model, comprising:
a plurality of non-volatile memory devices; and
a storage controller connected to the plurality of non-volatile memory devices through a plurality of channels, and configured to control the plurality of non-volatile memory devices,
wherein the storage controller manages a channel table, and
wherein the channel table includes:
a relationship between a first data type and a channel, among the plurality of channels, to which next data of the first data type are to be sent; and
a relationship between a second data type and a channel, among the plurality of channels, to which next data of the second data type are to be sent.

12. The storage device of claim 11, wherein the first data type is a first key matrix,
wherein the second data type is a first value matrix, and
wherein the first key matrix and the first value matrix are included in a first layer of the large language model.

13. The storage device of claim 11, wherein the storage controller is configured to:
transfer a first key vector corresponding to the first data type to at least one first non-volatile memory device connected through one or more first channels, among the plurality of channels; and
update the channel table such that a channel corresponding to the first data type is changed to a second channel among the plurality of channels.

14. The storage device of claim 13, wherein the channel table further includes a relationship between the first data type and a way constituted by a first non-volatile memory device corresponding to the next data of the first data type.

15. The storage device of claim 13, wherein the storage controller is configured to:
transfer a second key vector corresponding to the first data type to at least one second non-volatile memory device connected through one or more third channels among the plurality of channels; and
update the channel table such that the channel corresponding to the first data type is changed to a fourth channel among the plurality of channels.

16. The storage device of claim 15, wherein at least one of the one or more third channels is included in the one or more first channels.

17. An electronic device which implements inference of a large language model, comprising:
a processor configured to perform learning and the inference of the large language model; and
a storage device configured to store model data of the large language model and provide the model data to the processor,
wherein the storage device includes:
a storage controller configured to control the storage device; and
a plurality of non-volatile memory devices connected to the storage controller through a plurality of channels, and configured to store the model data, and
wherein the storage controller is further configured to manage a channel table including a relationship between a first data type and a channel to which next data of the first data type are to be sent.

18. The electronic device of claim 17, wherein the channel table further includes a relationship between a second data type and a channel to which next data of the second data type are to be sent.

19. The electronic device of claim 18, wherein the storage controller is configured to:
manage a mapping table indicating a relationship between a logical address of the processor and a physical address of the storage device;
send a first key vector corresponding to the first data type to at least one first non-volatile memory device included in the plurality of non-volatile memory devices through one or more first channels among the plurality of channels; and
update the channel table such that a channel corresponding to the first data type is changed to a second channel among the plurality of channels.

20. The electronic device of claim 19, wherein the at least one first non-volatile memory device constitutes a first way.
